(19) United States
(12) Patent Application Publication
(10) Pub. No.: US 2016/0267541 A1
(43) Pub. Date: Sep. 15, 2016

(54) SYSTEM AND METHOD FOR MERCHANDISING

(71) Applicant: FIRSTNOD, LLC, Colorado Springs, CO (US)

(72) Inventor: Joseph S. Breakey, Colorado Springs, CO (US)

(21) Appl. No.: 15/032,570

(22) PCT Filed: Oct. 28, 2014
(86) PCT No.: PCT/US14/62733

§ 371 Date: Apr. 27, 2016

Related U.S. Application Data
(60) Provisional application No. 61/896,643, filed on Oct. 28, 2013.

(51) Int. Cl. G06Q 30/02; H04W 4/12; G06Q 50/00

(52) U.S. Cl. CPC G06Q 30/0267; G06Q 50/01; H04W 4/12; G06Q 30/0259; G06Q 30/0233

(57) ABSTRACT

An experience-centric merchandising platform is accessible and operable by merchants and consumers via the web and various mobile platforms, empowering merchants and consumers to self-direct and self-manage marketing campaigns and individual shopping experiences. A merchandising platform includes a marketing message generation module, a cross marketing module, a transaction fee processing module, a voucher generation module, and an on-demand spot marketing module.

The present application claims the benefits of and priority, under 35 U.S.C. §119(e), to U.S. Provisional Application Ser. No. 61/896,643, filed Oct. 28, 2013, entitled “System and Method for Merchandising;” each of the above-identified applications being fully incorporated herein by reference.

### BACKGROUND

1. Field of the Invention

This invention relates generally to merchandising and specifically to apparatus, systems, and/or methods for an experience-centric merchandising platform.

2. Discussion of the Background

With 100 million Facebook users, 2.4 billion Internet users and the prediction that there will be over 7.3 billion active mobile phones by the end of 2014, representing more in-use cell phones than there are people on the planet right now; merchants' desire to better manage and target their marketing dollars and consumers' desire to better define and embrace merchant touch points are at an all time high and growing. Traditional methods of marketing are becoming obsolete, superseded by innovative approaches that must engage consumers in a timelier, relevant manner. Merchants must adapt by providing a rich consumer-centric experience that reflects a more informed, empowered and demanding “smart” consumer.

Today's global merchandising environment is undergoing a dramatic shift as consumer expectations and merchant demand for marketing flexibility and increased ROI reach unprecedented highs. Consumer touch points continue to evolve as mobile devices gain momentum; social media outlets, such as Facebook and Instagram and deal of the day sites (DOD), such as LivingSocial, Groupon and local DOD franchises compete to attract new consumers. While the interaction between consumers and merchants continues to expand beyond the physical store, merchants continue to struggle trying to define the best approach to streamline and monetize these interactions.

### SUMMARY OF THE INVENTION

Therefore, there is a need for an experience-centric merchandising platform that addresses the above deficiencies and other problems in the related art.

One advantage includes merchant controlled messaging. Merchant has full control to develop marketing messaging and publishing the same using sophisticated automated processes and self-service tools encapsulated. As merchant enters marketing message information, to dynamically build marketing message is dynamically built for multiple marketing message platforms.

Another advantage includes merchant controlled pricing and timing. Product and service price structure is defined by the merchant differentiating an embodiment from the related art. Merchant can tailor their price structure and discounting based on their unique business needs and product and service availability.

Yet another advantage includes merchant controlled timing and availability. Merchants define when offered products and services are available for purchase down to 15-minute increments. Marketing campaigns can have a life of 1-day and only during specific times during that day or may span multiple days and multiple times per day. Different from the related art, merchants can manage their business and ROI by excluding specific primetime dates and time frames (e.g. weekends and prime meal times).

Yet another advantage includes automated location based cross marketing. Merchant can publish marketing campaigns using the platform's automated location based marketing services targeting consumers who are known to be in the general area of the merchant. An example, consumer is at merchant #1's location and redeems a voucher. Merchant #2 can pre-publish an offer that is automatically pulled and delivered to the consumer if consumer redeems another merchant's voucher (e.g., merchant #1) within a defined distance from merchant #2.

Yet another advantage includes small unit quantity offerings. Merchant has control over how many units they want to offer for sale and the maximum any one person can claim. Merchants are not required to offer high unit quantities for extended periods of time.

Yet another advantage includes immediate increase in ROI. A key differentiator of an embodiment is consumers pay the merchant directly which is different from related art models where consumers pays the third party DOD site and the DOD site remits net of DOD fees (and holdbacks) to the merchant over a prolonged 30-60 period after consumer receives merchant product or services. With the invention, merchant achieves an immediate increase in ROI on the very first sale and no longer has to wait 30-60 days to be paid after their product or service is delivered.

Yet another advantage includes merchant transaction fee processing. A method provides configurable and flexible technology and processes for calculating and collecting minimum transaction fees from merchant for published marketing campaigns and vouchers redeemed by merchant and the offsetting of minimum transaction fee by the amount of redeemed voucher transaction fee.

Yet another advantage includes target market flexibility. Merchant has flexibility to market to their private contact lists differently than social media prospects. Merchant can upload their private contact list and launch marketing campaigns to their private contact list target audience differently than social media prospects. The result is an increase on ROI given merchants can entice existing consumers with offers that help ensure customer loyalty and help reduce the need to discount to get repeat business.

Yet another advantage includes automated voucher generation, validation, and redemption. A method provides a unique and flexible merchant and user experience with respect to voucher generation, management, and redemption.

Yet another advantage includes on-demand spot marketing. An embodiment of a spot market method is designed to support merchants who are looking to maximize their ROI through marketing campaigns, developed using the invention, designed to attract user to purchase products and services from merchant during merchant defined down times or slow periods. This is a merchant self-service method where the merchant can develop and publish a spot market campaign without the help of the vendor.

Yet another advantage includes low cost of ownership. Merchant upfront and ongoing costs are significantly lower than the related art.

Another advantage includes consumers not having to pay up front for products and services. An embodiment provides a non-financially invasive solution to consumers where they do not pay for products and services upfront and before the product or service is provided or delivered to the consumer. Instead, consumer receives an electronic voucher, which is then presented electronically or on paper to the merchant, and pays the merchant directly when the product or service is provided.

Yet another advantage includes consumer defining and pulling marketing messaging. An embodiment provides consumers with a direct means for defining, updating, changing, or modifying their unique marketing profile and filters so that only requested merchant marketing material, of interest to the consumer, is pulled and delivered to the consumer. Consumer's marketing profile can encompass fixed and mobile distance from merchant, product category and sub categories, time, weather conditions, special events and frequency of notifications.

The present disclosure can provide a number of advantages depending on the particular aspect, embodiment, and/or configuration. These and other advantages will be apparent from the disclosure. Additional features and advantages may be learned by the practice of the invention.

To achieve these and other advantages, as embodied and broadly described, a method of merchandising using a merchandising platform comprises creating or updating a marketing campaign with one or more data fields related to the marketing campaign, and building one or more marketing messages. Each of the marketing messages corresponding to a messaging platform, and each of the marketing messages conforming to one or more rules of the corresponding messaging platform. The method further comprises publishing the marketing campaign on the merchandising platform and at least one of the marketing messages on the corresponding messaging platform.

In an aspect, the method further comprises determining one or more target users to receive the marketing campaign and transmitting to the target users the at least one of the marketing messages. In an aspect, the method further comprises determining a preference of the target users for receiving the marketing messages with the corresponding messaging platforms, and wherein the at least one of marketing messages corresponds to the preference. The marketing campaign is private and only available to the target users.

In an aspect, the one or more data fields includes one or more of descriptive information of a product or service of the marketing campaign, a merchant location information where the product or service is available, a number of units of where the product or service is available for the marketing campaign, and a date or time of availability.

In an aspect, the marketing message includes a pointer to a third party system managing or related to the marketing campaign.

In an aspect, the one or more rules is based on one or more of element restrictions mandated by the corresponding message platform. In an aspect, the building the each of the one or more marketing messages comprises weighting the data fields according to the element restrictions mandated by the corresponding message platform and building the each of the marketing messages according to a priority of the weighted data fields. In an aspect, the element restrictions include one or more of a format, length, or image embedding restriction.

In an aspect, the method further comprises storing one or more of the marketing campaign and the marketing messages to a database.

In an aspect, the corresponding messaging platform meets a preference of a merchant of the marketing campaign.

In an embodiment, a method of merchandising using a merchandising platform comprises receiving a notification of a redemption event of a voucher for a first marketing campaign, determining a physical location of a user of the voucher in the redemption event and determining one or more marketing campaigns within a proximity of the physical location. The one or more marketing campaigns meets one or more preferences of the user and a respective merchant of each of the marketing campaigns. The method further comprises presenting the one or more marketing campaigns to the user.

In an aspect, the determining the physical location is based on one or more of a global positioning, triangulation, trilateration, and multilateration wireless location determining process of a device of the user used in the redemption event.

In an aspect, the determining the physical location is based on a location of a merchant of the first marketing campaign. In an aspect, the location of the merchant is provided by the merchant through the redemption event.

In an aspect, the physical location is one of a current location, home location, and work location of the user.

In an aspect, the proximity of the physical location is based on one or more of a distance and a time of travel to the physical location.

In an aspect, the method further comprises prioritizing the one or more marketing campaigns based on one or more of the proximity and the preferences of the user. In an aspect, the prioritizing comprises weighing the proximity and the preferences of the user.

In an aspect, the preferences of the merchant include discriminating the user based on one or more of a pre-determined list of users and attributes or the preferences of the user.

In an embodiment, a method of merchandising using a merchandising platform comprises receiving a notification of a redemption event of a voucher for a marketing campaign, retrieving rules related to transaction fee for the marketing campaign related to the voucher, and calculating a unit transaction fee for the voucher based on a number of pricing tiers, where a number of units for each of the pricing tiers, and a unit pricing percentage for the each of the pricing tiers.

In an aspect, the method further comprises calculating the number of pricing tiers, the number of units for each of the pricing tiers, and the unit pricing percentage for the each of the pricing tiers based on the rules.

In an aspect, the method further comprises settling the unit transaction fee with a minimum transaction fee paid by a merchant of the marketing campaign, and responsive to the minimum transaction fee paid being insufficient, billing the merchant for the unit transaction fee.

In an aspect, the method further comprises increasing a count of the number of vouchers redeemed, wherein the count affects the pricing tier. In an aspect, the unit transaction fee is collected from the merchant prior to a publication of a marketing campaign.

In an aspect, the method further comprises settling the unit transaction fee with a minimum transaction fee paid by a merchant of the marketing campaign and, responsive to the minimum transaction fee paid being insufficient, settling the unit transaction fee from fee paid by the merchant for a second marketing campaign.

In an embodiment, a method of merchandising using a merchandising platform comprises receiving, from a user, a selection to claim an offer of a marketing campaign, generating a voucher for a marketing campaign, receiving, from a merchant, a notification of a redemption the voucher, validating restrictions on the redemption of the voucher, reporting a result of the validating to the merchant, and, responsive to the result being an invalid voucher, receiving, from the merchant, a selection to override the invalid voucher.

In an aspect, the method further comprises displaying a list of a plurality of marketing campaigns to the user, the list being filtered by a preference of the user.

In an aspect, the generating comprises embedding an identifier to the voucher.

In an aspect, the identifier comprises one or more of a barcode and a quick response (QR) code.

In an aspect, the identifier is configured to provide to the merchandising platform to retrieve one or more conditions of the voucher.

In an aspect, the notification is provided by a reader coupled to a merchant device.

In an aspect, the notification is provided by a manual input of the merchant to a merchant device

In an aspect, the validating comprises verifying one or more of a date, time, and weather condition at a time of the redemption to restrictions of the marketing campaign.

In an aspect, the method further comprises storing information related to the redemption in a database.

In an embodiment, a method of merchandising using a merchandising platform comprises creating or updating a marketing campaign with one or more data fields related to the marketing campaign, the data fields include a duration and a start time of the marketing campaign, storing the marketing campaign to a database, starting the marketing campaign at the start time, and publishing the marketing campaign on the merchandising platform.

In an aspect, the method further comprises building one or more marketing messages, each of the marketing messages corresponding to a messaging platform, and each of the marketing messages conforming to one or more rules of the corresponding messaging platform and publishing at least one of the marketing messages on the corresponding messaging platform. In an aspect, the method further comprises determining one or more target users to receive the marketing campaign and transmitting to the target users the at least one of the marketing messages. In an aspect, the method further comprises determining a preference of the target users for receiving the marketing messages with the corresponding messaging platforms. The at least one of the marketing messages corresponds to the preference.

In an aspect, the one or more data fields includes one or more of descriptive information of a product or service of the marketing campaign, a merchant location information where the product or service is available, a number of units of where the product or service is available for the marketing campaign, and a date or time of availability.

In an aspect, the marketing message includes a pointer to a third party system managing or related to the marketing campaign.

In an aspect, the start time is immediately.

In an aspect, the data fields include a discount to an existing marketing campaign, wherein the discount comprises one or more of a fixed price, a percent off, a dollar amount off, and a graduated pricing to the existing marketing campaign.

In an embodiment, a merchandising platform comprises one or more of (a)-(e) following:

(a) a marketing message generation module configured to create or update a marketing campaign with one or more data fields related to the marketing campaign; build one or more marketing messages, each of the marketing messages corresponding to a messaging platform, and each of the marketing messages conforming to one or more rules of the corresponding messaging platform; and publish the marketing campaign on the merchandising platform and at least one of the marketing messages on the corresponding messaging platform;
(b) a cross marketing module configured to receive a notification of a redemption event of a voucher for a first marketing campaign; determine a physical location of a user of the voucher in the redemption event; determine one or more marketing campaigns within a proximity of the physical location, the one or more marketing campaigns meeting one or more preferences of the user and a respective merchant of each of the marketing campaigns; and present the one or more marketing campaigns to the user;
(c) a transaction fee processing module configured to receive a notification of a redemption event of a voucher for a marketing campaign; retrieve rules related to transaction fee for the marketing campaign related to the voucher; and calculate a unit transaction fee for the voucher based on a number of pricing tiers, a number of units for each of the pricing tiers, and a unit pricing percentage for the each of the pricing tiers;
(d) a voucher generation module configured to receive, from a user, a selection to claim an offer of a marketing campaign; generate a voucher for a marketing campaign; receive, from a merchant, a notification of a redemption of the voucher; validate restrictions on the redemption of the voucher; report a result of the validating to the merchant; and responsive to the result being an invalid voucher, receive, from the merchant, a selection to override the invalid voucher; and
(e) an on-demand spot marketing module configured to create or update a marketing campaign with one or more data fields related to the marketing campaign, the data fields include a duration and a start time of the marketing campaign; store the marketing campaign to a database; start the marketing campaign at the start time; and publish the marketing campaign on the merchandising platform.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium,” as used herein, refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, an EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The term “module,” as used herein, refers to any known or later developed hardware, software, firmware, artificial intelligence, fuzzy logic, or combination of hardware and software that is capable of performing the functionality associated with that element.

The terms “determine,” “calculate,” and “compute,” and variations thereof, as used herein, are used interchangeably and include any type of methodology, process, mathematical operation or technique.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible, utilizing, alone or in combination, one or more of the features set forth above or described in detail below.

### BRIEF DESCRIPTION OF THE DRAWINGS

FIG. 1 illustrates an exemplary block diagram of a communication network for a tracking system according to an embodiment;

FIG. 2 illustrates an exemplary block diagram of a network device according to an embodiment;

FIG. 3 illustrates an exemplary block diagram of a server device according to an embodiment;

FIG. 4 illustrates an exemplary block diagram of a merchant device according to an embodiment;

FIG. 5 illustrates an exemplary block diagram of a consumer device according to an embodiment;

FIG. 6 illustrates an exemplary flow diagram of a marketing message dynamic generation and distribution process according to an embodiment;

FIG. 7A-7C illustrate exemplary flow diagrams of a marketing message dynamic generation and distribution process according to an embodiment;

FIG. 8 illustrates an exemplary flow diagram of a location based cross marketing process according to an embodiment;

FIG. 9 illustrates an exemplary flow diagram of a location based cross marketing process according to an embodiment;

FIG. 10 illustrates an exemplary flow diagram of a merchant transaction fee processing process according to an embodiment;

FIG. 11 illustrates an exemplary flow diagram of a merchant transaction fee processing process according to an embodiment;

FIG. 12 illustrates an exemplary flow diagram of a voucher generation, validation, and redemption process according to an embodiment;

FIG. 13 illustrates an exemplary flow diagram of a voucher generation, validation, and redemption process according to an embodiment;

FIG. 14 illustrates an exemplary flow diagram of an on-demand spot market process according to an embodiment; and

FIG. 15 illustrates an exemplary diagram of an ecosystem for a merchandising platform according to an embodiment.

### DETAILED DESCRIPTION

Embodiments herein presented are not exhaustive, and further embodiments may be now known or later derived by one skilled in the art.

Functional units described in this specification and figures may be labeled as modules, or outputs in order to more particularly emphasize their structural features. A module and/or output may be implemented as hardware, e.g., comprising circuits, gate arrays, off-the-shelf semiconductors such as logic chips, transistors, or other discrete components. They may be fabricated with Very-large-scale integration (VLSI) techniques. A module and/or output may also be implemented in programmable hardware such as field programmable gate arrays, programmable array logic, programmable logic devices or the like. Modules may also be implemented in software for execution by various types of processors. In addition, the modules may be implemented as a combination of hardware and software in one embodiment.

An identified module of programmable or executable code may, for instance, include one or more physical or logical blocks of computer instructions that may, for instance, be organized as an object, procedure, or function. Components of a module need not necessarily be physically located together but may include disparate instructions stored in different locations which, when joined logically together, include the module and achieve the stated function for the module. The different locations may be performed on a network, device, server, and combinations of one or more of the same. A module and/or a program of executable code may be a single instruction, or many instructions, and may even be distributed over several different code segments, among different programs, and across several memory devices. Similarly, data or input for the execution of such modules may be identified and illustrated herein as being an encoding of the modules, or being within modules, and may be embodied in any suitable form and organized within any suitable type of data structure.

In one embodiment, the system, components and/or modules discussed herein may include one or more of the following: a server or other computing system including a processor for processing digital data, memory coupled to the processor for storing digital data, an input digitizer coupled to the processor for inputting digital data, an application program stored in one or more machine data memories and accessible by the processor for directing processing of digital data by the processor, a display device coupled to the processor and memory for displaying information derived from digital data processed by the processor, and a plurality of databases or data management systems.

In one embodiment, functional block components, screen shots, user interaction descriptions, optional selections, various processing steps, and the like are implemented with the system. It should be appreciated that such descriptions may be realized by any number of hardware and/or software components configured to perform the functions described. Accordingly, to implement such descriptions, various integrated circuit components, e.g., memory elements, processing elements, logic elements, look-up tables, input-output devices, displays and the like may be used, which may carry out a variety of functions under the control of one or more microprocessors or other control devices.

In one embodiment, software elements may be implemented with any programming, scripting language, and/or software development environment, e.g., Fortran, C, C++, C#, COBOL, Apache Tomcat, Spring Roo, Web Logic, Web Sphere, assembler, PERL, Visual Basic, SQL, SQL Stored Procedures, AJAX, extensible markup language (XML), Flex, Flash, Java, .Net and the like. Moreover, the various functionality in the embodiments may be implemented with any combination of data structures, objects, processes, routines or other programming elements.

In one embodiment, any number of conventional techniques for data transmission, signaling, data processing, network control, and the like as one skilled in the art will understand may be used. Further, detection or prevention of security issues using various techniques known in the art, e.g., encryption, may be also be used in embodiments of the invention. Additionally, many of the functional units and/or modules, e.g., shown in the figures, may be described as being “in communication” with other functional units and/or modules. Being “in communication” refers to any manner and/or way in which functional units and/or modules, such as, but not limited to, input/output devices, computers, laptop computers, PDAs, mobile devices, smart phones, modules, and other types of hardware and/or software may be in communication with each other. Some non-limiting examples include communicating, sending and/or receiving data via a network, a wireless network, software, instructions, circuitry, phone lines, Internet lines, fiber optic lines, satellite signals, electric signals, electrical and magnetic fields and/or pulses, and/or the like and combinations of the same.

By way of example, communication among the users, subscribers and/or server in accordance with embodiments of the invention may be accomplished through any suitable communication channels, such as, for example, a telephone network, an extranet, an intranet, the Internet, cloud based communication, point of interaction devices (point of sale device, personal digital assistant, cellular phone, kiosk, and the like), online communications, off-line communications, wireless communications, RF communications, cellular communications, Wi-Fi communications, transponder communications, local area network (LAN) communications, wide area network (WAN) communications, networked or linked devices and/or the like. Moreover, although embodiments of the invention may be implemented with TCP/IP communications protocols, other techniques of communication may also be implemented using IEEE protocols, IPX, Appletalk, IP-6, NetBIOS, OSI or any number of existing or future protocols. Specific information related to the protocols, standards, and application software utilized in connection with the Internet is generally known to those skilled in the art and, as such, need not be detailed herein.

In embodiments of the invention, the system provides and/or receives a communication or notification via the communication system to or from an end user. The communication is typically sent over a network, e.g., a communication network. The network may utilize one or more of a plurality of wireless communication standards, protocols or wireless interfaces (including LTE, CDMA, WCDMA, TDMA, UMTS, GSM, GPRS, OFDMA, WiMAX, FLO TV, Mobile DTV, WLAN, and Bluetooth technologies), and may be provided across multiple wireless network service providers. The system may be used with any mobile communication device service (e.g., texting, voice calls, games, videos, Internet access, online books, etc.), SMS, MMS, email, mobile, land phone, tablet, smartphone, television, vibrotactile glove, voice carry over, video phone, pager, relay service, teletypewriter, and/or GPS and combinations of the same.

Traditional print based advertising remains on the decline and consumer frustration levels continue to increase as they are bombarded with often irrelevant, off target and unwanted electronic advertisements, distributed on the web and to mobile devices, directly by merchants and DOD outlets to consumers.

On the surface the premise of a DOD site is alluring for merchants looking to draw large numbers of new consumers to their business and improve their bottom line. What business doesn't want new customers? DOD sites generally dictate the structure of the marketing activity leaving merchants with little in the way of marketing, pricing, volume and timing flexibility. Merchants are required to commit to offering a large number of deeply discounted deals over a prolonged period of time.

The sales pitch related art DOD sites make to merchants is that 50% discounts on offered products and services and a commitment to high unit volumes (250 units or more) are essential in generating new sales and attracting new customers. DOD sites' large unit volume commitments are driven by their need to recover the high overhead costs they incur to develop, publish and maintain merchant messaging, marketing content, and support consumer service issues and refund process. Typical prior art model is; DOD site collects the discounted sale amount directly from the consumer and generally retains 50% of the sale proceeds to cover their fees and remits net of their fees to the merchant. Often times there are payment holdbacks in the amount of 20% to help cover the cost of dissatisfied customers and refund requests. In the end, merchants receive only 25% of the original retail amount of product or service sold net of any DOD site holdbacks.

Merchants are further impacted financially given they are typically not paid by DOD sites for 30-60 days after the date of sale creating a significant financial burden on the merchant as they have to float the variable cost (labor, inventory, materials, etc.) associated with providing consumers with products and services sold. Added to the financial burden of delayed payments, merchants have limited flexibility to control when sold services can be used resulting in consumers using discount vouchers during peak business times. In the case of restaurants, consumers purchasing a voucher may be free to use the voucher during prime dining hours (breakfast, lunch, dinner and weekends) resulting in additional financial strain on the merchant.

Merchants often struggle to absorb the increase in business, driven by high unit volume commitments, at deep discounts, that may or may not breakeven during prime business hours; resulting in the merchant absorbing a high volume of loss leaders. For every merchant that can bear the financial burden surrounding the typical DOD model we believe there are 50 to 100 times that number that cannot afford to absorb the financial and business impact imposed by typical DOD sites that are candidates to use the invention.

Today's consumer is faced with a wide variety of challenges from the growing number of social media outlets, and the expanding number of consumer touch points driven by the proliferation of mobile devices. The repeated bombardment of consumers with off target push-based marketing messages from online and social media sources continues to disenfranchise consumers. The smarter consumer desires to be engaged by merchants in a more transparent, timely, and consumer-unique manor with real-time connectivity into their buying preferences and process.

Today, consumers have little in the way of flexibility to filter out unwanted advertisements or configure their personal shopping profile to pull only marketing messages meeting individual consumer defined marketing filter criteria. No longer is a one size fits all marketing approach good enough for the “smart” consumer.

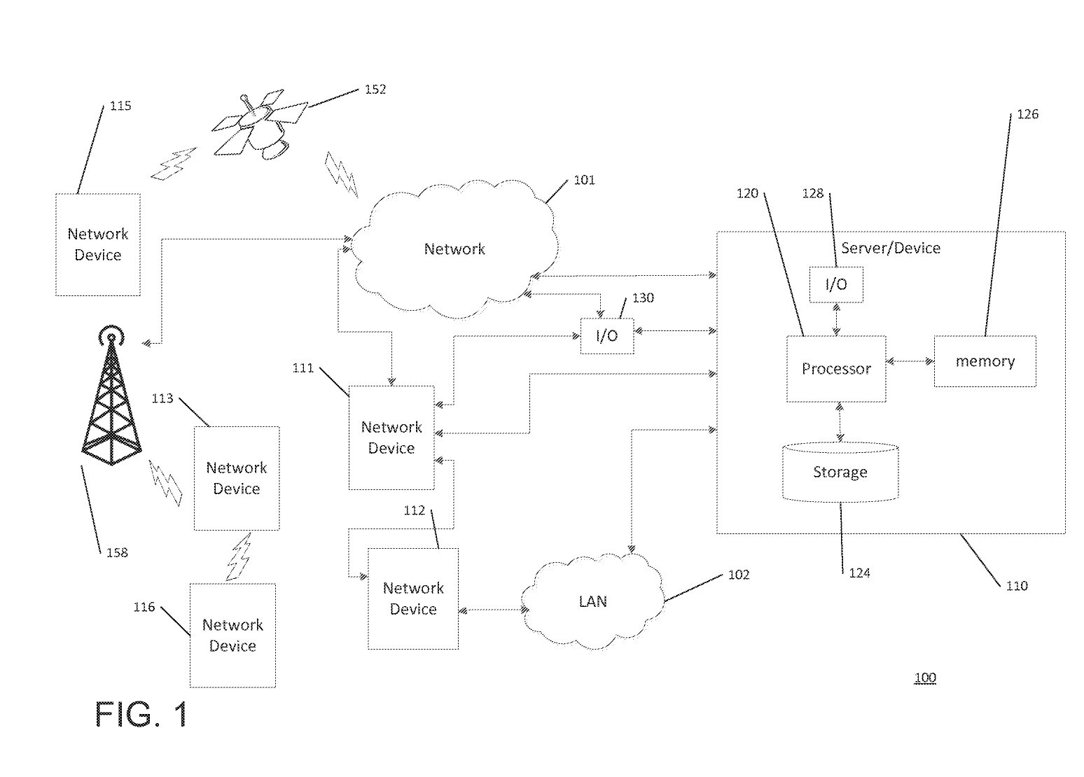

FIG. 1 illustrates an exemplary block diagram of a communication network according to an embodiment.

Referring to FIG. 1, communication network 100 includes one or more networks, including wide-area network 101, e.g., the Internet, company or organization Intranet, and/or sections of the Internet (e.g., virtual private networks, Clouds, and the Dark Web), and local-area network 102, e.g., interconnected computers localized at a geographical and/or organization location and ad-hoc networks connected using various wired means, e.g., Ethernet, coaxial, fiber optic, and other wired connections, and wireless means, e.g., Wi-Fi, Bluetooth, and other wireless connections. Communication network 100 includes a number of network devices 110-115 that are in communication with the other devices through the various networks 101 and 102 and through other means, e.g., direct connection through an input/output port of a network device 130, direct connection through a wired or wireless means, and indirect connection through an input-output box, e.g., a switch.

Network devices 110-115, which may also connect through the networks 101 and 102 using various routers, access points, and other means. For example, network device 113 wirelessly connects to a base station 158, which acts as an access point to the wide area network 101. Base station 158 may be a cellular phone tower, a Wi-Fi router or access point, or other devices that allow a network device, e.g., wireless network device 113, to connect to a network, e.g., wide area network 101, through the base station 158. Base station 158 may be connected directly to network 101 through a wired or wireless connection or may be routed through additional intermediate service providers or exchanges. Wireless device 113 connecting through base station 158 may also act as a mobile access point in an ad-hoc or other wireless network, providing access for network device 115 through network device 113 and base station 158 to network 101.

In some scenarios, there may be multiple base stations, each connected to the network 101, within the range of network device 113. In addition, a network device, e.g., network device 113, may be travelling and moving in and out of the range of each of the multiple base stations. In such case, the base stations may perform handoff procedures with the network device and other base stations to ensure minimal interruption to the network device's connection to network 101 when the network device is moved out of the range of the handling base station. In performing the handoff procedure, the network device and/or the multiple base stations may continuously measure the signal strength of the network device with respect to each base station and handing off the network device to another base station with a high signal strength to the network device when the signal strength of the handling base station is below a certain threshold.

In another example, a network device, e.g., network device 115, may wirelessly connect with an orbital satellite 152, e.g., when the network device is outside of the range of terrestrial base stations. The orbital satellite 152 may be wirelessly connected to a terrestrial base station that provides access to network 101 as known in the art.

In other cases, orbital satellite 152 or other satellites may provide other functions such as global positioning and providing the network device with location information or estimations of location information of the network device directly without needing to pass information to the network 101. The location information or estimation of location information is known in the art. The network device may also use geolocation methods, e.g., measuring and analyzing signal strength, using the multiple base stations to determine location without needing to pass information to the network 101. In an embodiment, the global positioning functionality of the orbital satellite 152 may use a separate interface than the communication functionality of the orbital satellite 152 (e.g., the global position functionality uses a separate interface, hardware, software, or other components of the network device 113 than the communication functionality). In another embodiment, the orbital satellite with the global position functionality is a physically separate satellite from the orbital satellite with communication functionality.

In one scenario, network device, e.g., network device 112, may connect to wide area network 101 through the local area network 102 and another network device, e.g., network device 110. Here, the network device 110 may be a server, router, gateway, or other devices that provide access to wide area network 101 for devices connected with local area network 102.

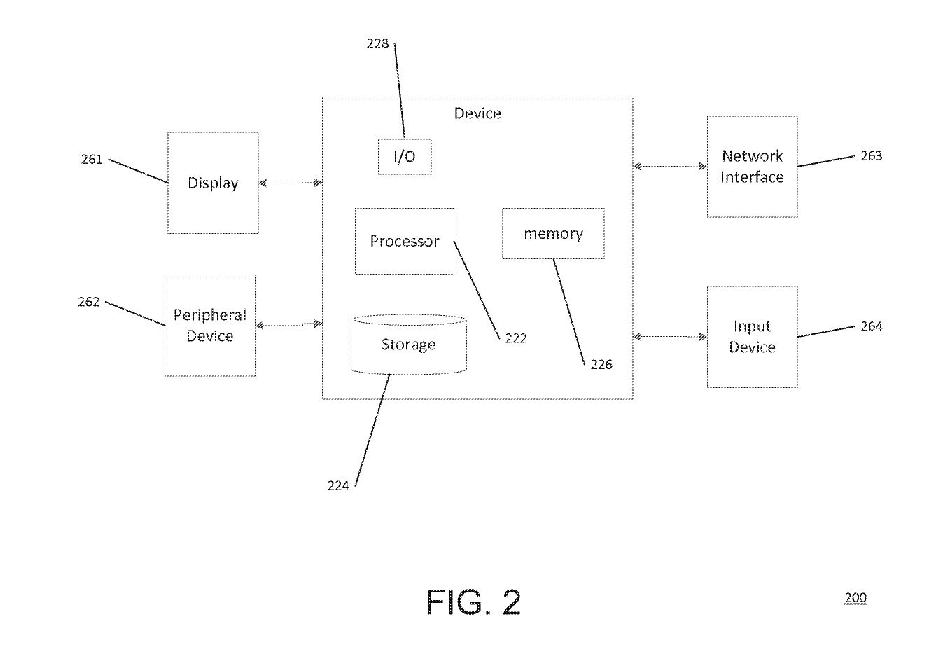

FIG. 2 illustrates an exemplary block diagram of a network device according to an embodiment.

Referring to FIG. 2, a network device 200 may include electronic components that include one or more processors 222, storages 224, memories 226, and input and output interfaces 228. A network device may or may not contain all of the above components depending on the purpose and use of the device. For example, the electronic components of a network device 200 may only be a dummy terminal that only requires an input and an output interface to send the input and receive the output from a device that contains a processor for processing the input and outputs.

In a further embodiment, the network device 200 may be connected with one or more displays 261, peripheral devices 262, and input devices 264. Displays 261 may be visible screens, audible speakers, Braille text devices, or other devices that output information to a user. Peripheral devices 262 may include printers, external storages, and other devices. Input devices 264 may include keyboards, mice, and other input devices to input information to the device 200. The one or more devices may be connected with or integral to the device 200. For example, a network device 200 may have an integrated display which may pull up an input device, e.g., a soft keyboard, in a touch screen of the display. Another device may have a separate display monitor connected to a display port, e.g., VGA, DVI, and HDMI, of the network device 200 and a hardware keyboard connected to the network device 200 through an input port, e.g., keyboard port and USB. The displays, peripheral devices, and input devices facilitate local user input and output at the location of the network device 200.

In an embodiment, network device 200 may include network input and output interfaces 263 for communication through communication network 101 as one of the network devices 110-115. Network interfaces 263 may include wired and wireless interfaces, as described with respect to FIG. 1, that connect the network device 200 to a network or other devices. The network interfaces 263 are used to receive input (e.g., instructions) to the network device 200 and transmit output (e.g., device status and updates) from the network device 200 to the network or other devices.

In an embodiment, the network device 200 may be one or more of, a combination of, or a part of a desktop or laptop computer, tablet computers, mobile phone, and other device that may access the network 101 as now known or as may be later derived.

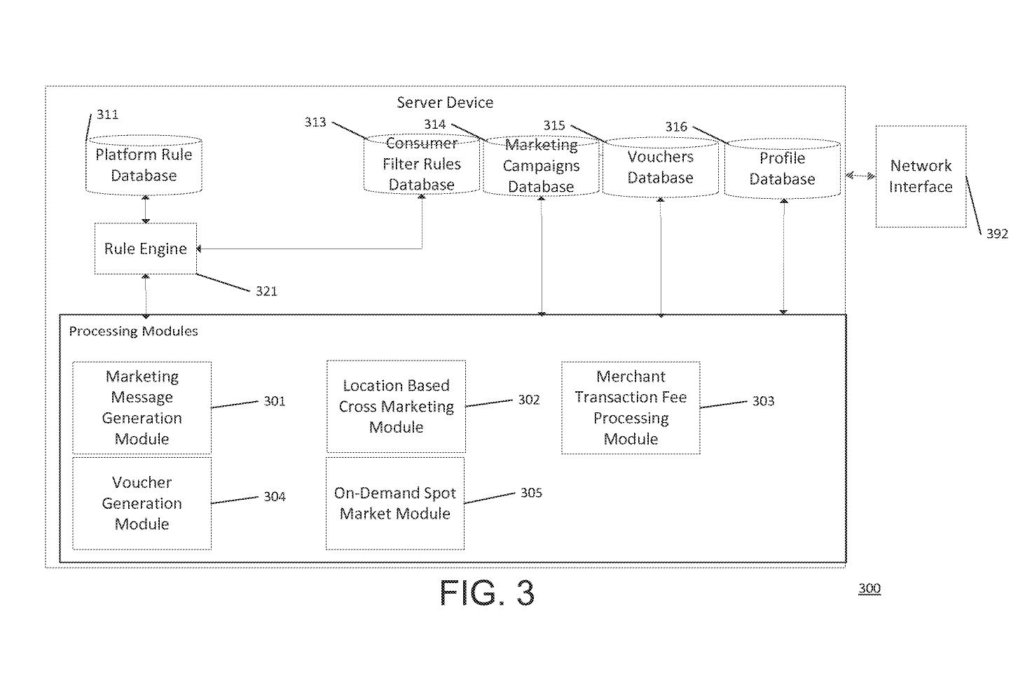

FIG. 3 illustrates an exemplary block diagram of a server device according to an embodiment.

In an embodiment, the server device 300 corresponds to the service device 110 that is configured to communicate with a plurality of network devices (e.g., network devices 111-115) through the networks 101 and 102 through the network interface 392.

The server device 300 includes a number of processing modules configured for performing the processing related to the merchandising platform. The processing modules include the marketing message generation module 301, the location based cross marketing module 302, the merchant transaction fee processing module 303, the voucher generation module 304, and the on-demand spot market module 305. In an embodiment, the processing modules 301-305 may be implemented as separate or a combination of one or more executable code modules stored in memory 226 and/or storage 224 and processed by a generic or specialize processor 222.

The server device 300 also includes a number of databases configured for storing and retrieving data related to the performance of the processes of modules 301-305. The databases include the platform rule database 311, the consumer filter rule database 313, the market campaign database 314, the voucher database 315, and the profile database 316. In an embodiment, the databases 311 and 313-316 may be implemented as separate or a combination of one or more databases or storage units and may be stored by storage 224.

For example, the platform rule database 311 includes the rules for building a market campaign or other messages on a particular messaging platform (e.g., email, SMS, push notification, Facebook, Twitter, or other platforms). A platform may include limitation on formatting (plain text for SMS, character limitation for Twitter or push notification, etc.). The platform rule may be used by the processing modules 301-305 (e.g., the marketing message generation module 301) to generate a particular marketing message into a message platform acceptable format (optionally, through the use of the rule engine 321).

In another example, the consumer filter rules database 313 includes a plurality of consumer filter rules that indicates preferences of the consumers for filtering marketing messages. For each consumer, the consumer filter rule may correspond to the consumer filter rule 512 of the consumer device 500. Example filter includes category filter (for filtering products, services, businesses, and other related groups of different categories (e.g., apparel, auto, electronics, entertainment, family, food, fun, health, home, over 21, pets, and travel) and subcategories (e.g., kid's clothing, men's clothing, women's clothing for apparels, auto care and wash, detailing, oil change and lube, repair and parts, security systems, tires/tire rotations, and windshield and repair for auto, etc.)). Other filters may include a distance filter from a home or a mobile device (e.g., consumer device 500) of the merchant and/or service, estimated drive time from the merchant and/or service, weather related rules (e.g., temperature, precipitation condition, etc.), the time of the day, day of the week, and/or other conditions.

In another example, the market campaigns database 314 includes one or more of the plurality of merchant's marketing campaigns for each merchant. Each marketing campaign may further include or be associated with historical information related to the marketing campaign (e.g., if the marketing campaign has previously been active), claimed vouchers of the marketing campaign, and/or analytics for the merchant campaign.

In an embodiment, the marketing campaigns database 314 may include marketing campaigns and marketing campaign rules for cross marketing (e.g., the marketing campaigns marked for sending to a consumer after another marketing campaign of the merchant or another merchant is redeemed). In another embodiment, the cross marketing campaigns may be stored in a separate database from the market campaigns database 314.

In an embodiment, the server device 300 may include one or more rule engines 321 configured for working with rules (which may be stored in the rule databases 311-313) and building the respective platform messages, market campaigns, and/or campaign filters as a service for the modules 301-305. In an embodiment, the rule engine 321 may be a part of the processing modules 301-305.

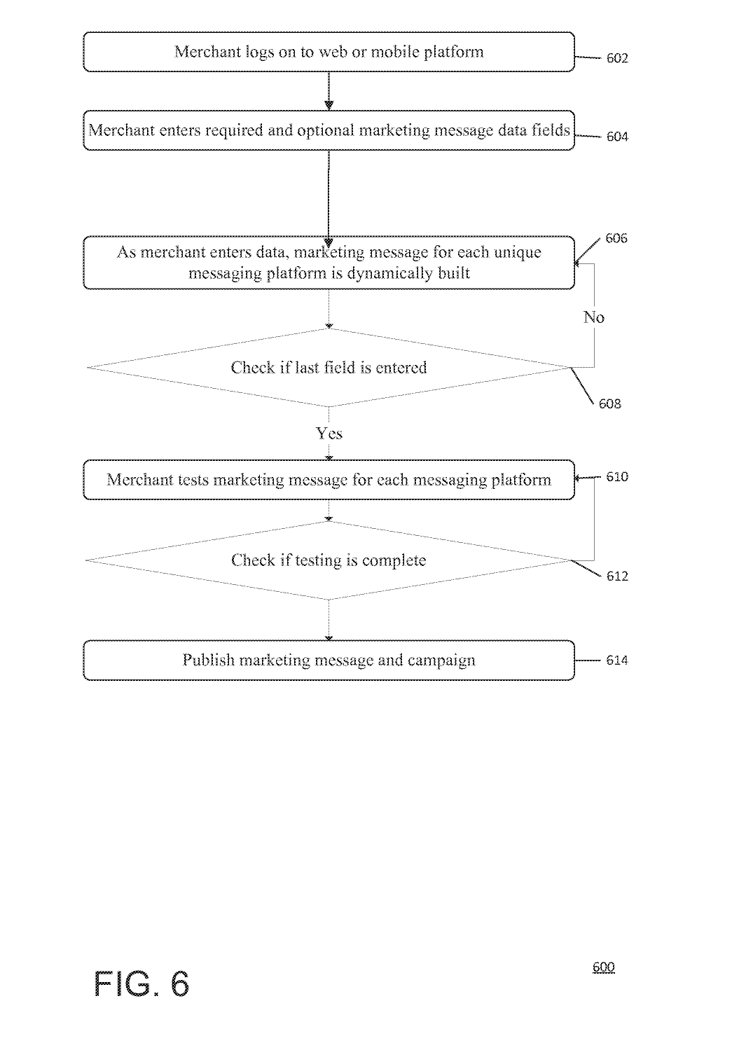

The processing modules 301-305 and the databases 311-316 will be described in further details with respect to FIGS. 6-14 below.

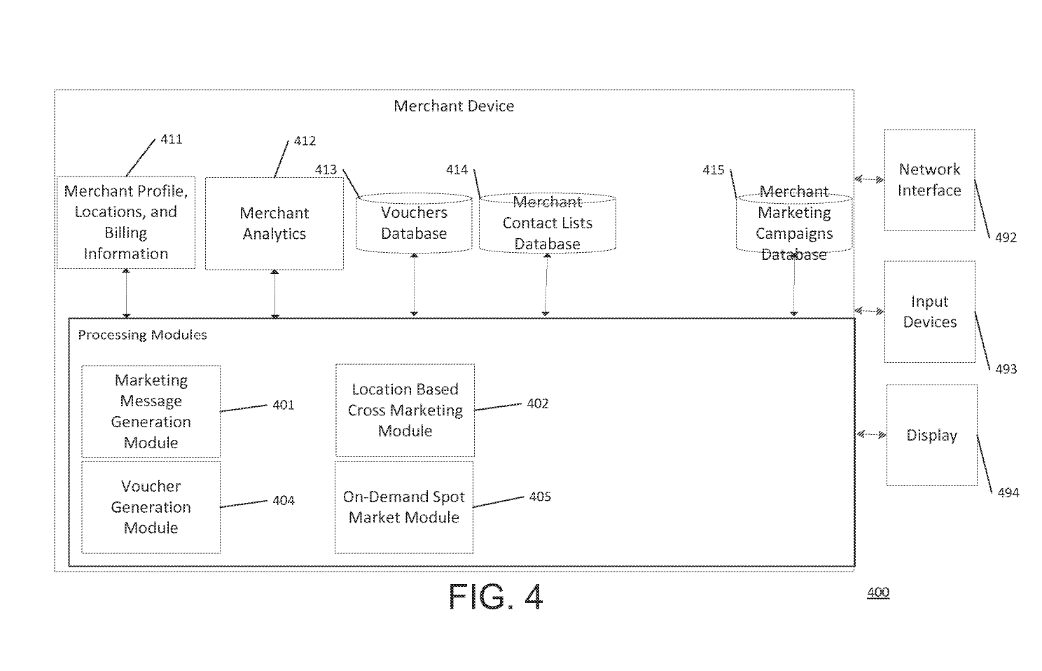

FIG. 4 illustrates an exemplary block diagram of a merchant device according to an embodiment.

In an embodiment, the merchant device 400 corresponds to the network devices 111-115 that is configured to communicate with at least server 110 (e.g., server device 300) and/or a plurality of network devices (e.g., network devices 111-115) through the networks 101 and 102 through the network interface 492. The merchant device 400 may also include input devices 493 and display 494.

The merchant device 400 includes a number of processing modules configured for performing the processing related to the merchandising platform. The processing modules include the marketing message generation module 401, the location based cross marketing module 402, the merchant transaction fee processing module 403, the voucher generation module 404, and the on-demand spot market module 405. In an embodiment, the processing modules 401-405 may be implemented as separate or a combination of one or more executable code modules stored in memory 226 and/or storage 224 and processed by a generic or specialized processor 222.

In another embodiment, the merchant device 400 may host an application (e.g., mobile device apps), a virtual interface (e.g., a web browser), or the like by which the modules 401-405 may be on a remote server (e.g., server device 300). The merchant device 400 acts as a virtual machine or as an interface component of the server device 300 for providing the processing modules 401-405 to the merchant. As such, the processing of the processing modules 401-405 are physically performed at a server device 300.

The merchant device 400 also includes a number of storage configured for storing and retrieving data related to the performance of the processes of modules 401-405. These include storage for merchant profile, locations, and billing information 411, merchant analytics 412, a vouchers database 413, a merchant contact lists database 414, and a merchant marketing campaigns database 415. In an embodiment, the storages may be implemented as separate or a combination of one or more databases or storage units and may be stored by storage 224. In another embodiment, the storages may be provided remotely (e.g., by the server device 300). In a further embodiment, the marketing campaign storage may be the same as or a part of another database of the remote server (e.g., merchant campaign rule database 312 and market campaign database 314), which may provide simultaneous and/or concurrent storage and update to the server and the merchant database.

For example, the merchant profile, locations, and billing information 411 includes the various merchant information. The merchant profile includes information regarding the business entity of the merchant, which may include the merchant's business (corporate) address, contact information etc. The merchant locations may include a list of the merchant's business locations and contact information for each location. The merchant billing information may include information such as the subscription plan with the merchandising platform, payment and transaction information (e.g., credit card processor, Paypal, etc.). The merchant billing information may further contain the billing and/or transaction history of the merchant's previous use of the platform.

In another example, the merchant analytics 412 includes history related to the merchant's activities, marketing campaigns, vouchers, revenue achievements, rate of return (ROI) information, trends, and other information. The relevant merchant analytics may be generated by the server device 300 and stored on the merchant device 400.

In another example, the vouchers database 413 is similar to vouchers databases 313 and 513 and keeps track of the vouchers related to the merchant. For example, the vouchers in the vouchers database 413 may be related to vouchers generated by the consumer and the history (e.g., the consumer claiming the voucher, when claimed, value, etc.) and the status of each of the vouchers.

In another example, the merchant contact lists database 414 stores and maintains one or more merchant unique contact lists that is provided by the merchant. For example, the merchant may keep one or more mailing lists (e.g., email list of customers or contacts) to which the merchant may wish to provide information regarding marketing campaigns of the merchant.

In another example, the merchant marketing campaigns database 415 includes one or more of the merchant's marketing campaigns. Each marketing campaign may further include or be associated with historical information related to the marketing campaign (e.g., if the marketing campaign has previously been active), claimed vouchers of the marketing campaign, and/or analytics for the merchant campaign.

In an embodiment, the merchant marketing campaigns database 415 may include marketing campaigns and marketing campaign rules for cross marketing (e.g., the marketing campaigns marked for sending to a consumer after another marketing campaign of the merchant or another merchant is redeemed). In another embodiment, the cross marketing campaigns may be stored in a separate database from the market campaigns database 415.

The processing modules 401-402 and 404-405 and the storages 411-415 will be described in further details with respect to FIGS. 6-14 below.

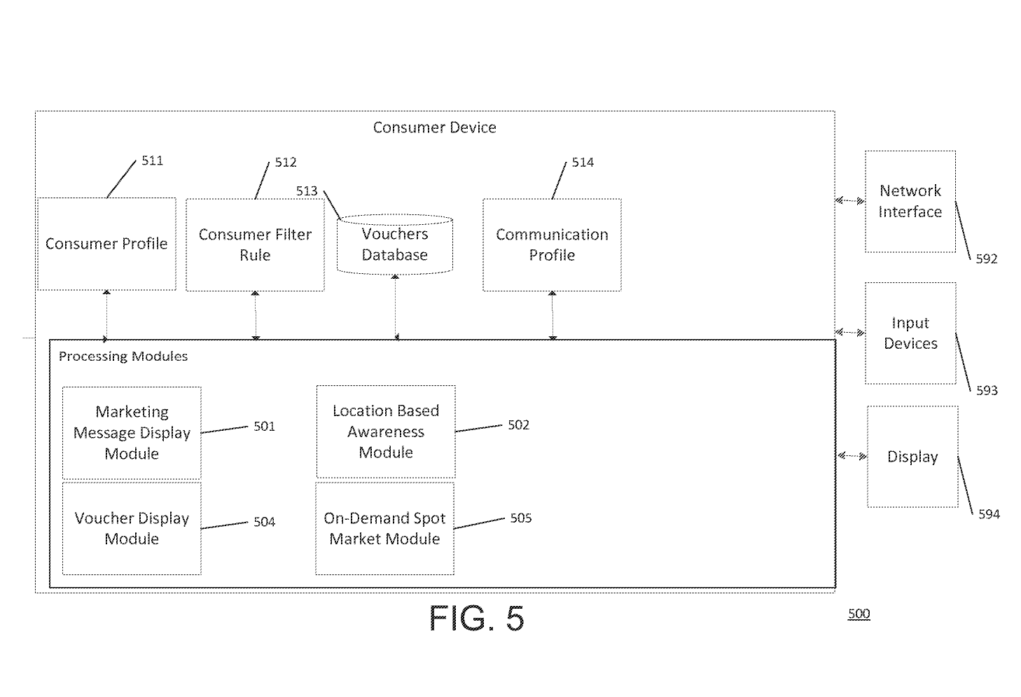

FIG. 5 illustrates an exemplary block diagram of a consumer device according to an embodiment.

In an embodiment, the consumer device 500 corresponds to the network devices 111-115 that is configured to communicate with at least server 110 (e.g., server device 300) and/or a plurality of network devices (e.g., network devices 111-115) through the networks 101 and 102 through the network interface 592. The consumer device 500 may also include input devices 593 and display 594.

The consumer device 500 includes a number of processing modules configured for performing the processing related to the merchandising platform. The processing modules include the marketing message generation module 501, the location based cross marketing module 502, the voucher redemption module 504, and the on-demand spot market module 505. In an embodiment, the processing modules 501-502 and 504-505 may be implemented as separate or a combination of one or more executable code modules stored in memory 226 and/or storage 224 and processed by a generic or specialized processor 222.

In another embodiment, the consumer device 500 may host an application (e.g., mobile device apps), a virtual interface (e.g., a web browser), or the like by which the modules 501-505 may be is run on a remote server (e.g., server device 300). The consumer device 500 acts as a virtual machine or as an interface component of the server device 300 for providing the processing modules 501-502 and 504-505 to the consumer. As such, the processing of the processing modules 501-502 and 504-505 are physically performed at a server device 300.

The consumer device 500 also includes a number of storages configured for storing and retrieving data related to the performance of the processes of modules 501-502 and 504-505. The storages include storage for consumer profile 511, consumer filter rule 512, a vouchers database 513, and communication profile 514. In an embodiment, the storages may be implemented as separate or a combination of one or more databases or storage units and may be stored by storage 224. In another embodiment, the storages may be provided remotely (e.g., by the server device 300). In a further embodiment, the storages may be the same as or a part of another database of the remote server (e.g., consumer filter rule database 313), which may provide simultaneous and/or concurrent storage and update to the server and the consumer database.

For example, the consumer profile 511 may contain the consumer's phone number, address, gender, date of birth along with other key data elements about the consumer as they become available or is gathered. This information may be used for filtering of marketing messages (in conjunction with a consumer filter rule 512 or other criteria, such as a minimum age requirement for certain products (e.g., tobacco, alcohol, or other controlled substances) or services (e.g., dating or adult entertainment) and maintaining identification and contact information of the consumer. In addition, the consumer profile 511 may also include (in secured storage (e.g., encryption) or in a verifiable form (e.g., one-way hash function) the user ID and password of the consumer for accessing the various services of the platform (e.g., the services of the server device 300).

In another example, the consumer filter rule 512 may include one or more filters for filtering marketing messages. The consumer filter rule 512 may also be stored in the consumer filter rule database 313 of the server device 300. Example filter includes category filter (for filtering products, services, businesses, and other related groups of difference categories (e.g., apparel, auto, electronics, entertainment, family, food, fun, health, home, over 21, pets, and travel) and subcategories (e.g., kid's clothing, men's clothing, women's clothing for apparels, auto care and wash, detailing, oil change and lube, repair and parts, security systems, tires/tire rotations, and windshield and repair for auto, etc.)). Other filters may include a distance filter from a home or a mobile device (e.g., consumer device 500) of the merchant and/or service, estimated drive time from the merchant and/or service, weather related rules (e.g., temperature, precipitation condition, etc.), the time of the day, day of the week, and/or other conditions.

In another example, the vouchers database 513 is similar to vouchers databases 413 and 313 and keeps track of the vouchers related to the consumer. For example, the vouchers in the vouchers database 513 may be related to vouchers claimed by the consumer and the history (e.g., when claimed, value, etc.) and the status of each of the vouchers.

In another example, the communication storage 514 contains information on the messaging platforms the user may want to use when a marketing campaign is sent to the consumer. For example, a user may only want to be informed of a marketing campaign using only one or more of: email, SMS, Facebook, Twitter, push notification, or other messaging platform. The communication storage 514 stores the authorized messaging platform of the user, which may be used by the processing modules (e.g., marketing message display module 501) for receiving the marketing message for displaying to the user.

The processing modules 501-502 and 504-505 and the storages 511-514 will be described in further details with respect to FIGS. 6-14 below.

As such, an embodiment is to provide an experience-centric merchandising platform with the preferred embodiment accessible and operable by merchants and consumers via the web and various mobile platforms. The merchandising platform empowers merchants and consumers to self-direct and self-manage marketing campaigns and individual shopping experience. It automates processes to solve deficiencies found with current one-size fits all merchant/consumer merchandising models and includes automated processes to manage the gap between consumer expectations and retailer reality.

An embodiment transitions consumer shopping experience away from traditional push based marketing to a consumer preferred pull based marketing model where, based on consumer defined marketing preferences, only marketing messages the consumer wants to see and when they want to see them are automatically pulled from a dynamic marketing database containing marketing characteristics which are automatically filtered (rules) using consumer defined filter criteria and automatically pulled and delivered to the consumer. Some embodiments may be either push, pull or both. The principal objective of the invention is a multifaceted transformation of merchant marketing and consumer shopping experiences that spans people, processes, information and technology. An embodiment delivers a much improved, more dynamic, rule based, user configurable platform with real-time connectivity between merchants and consumer buying process. An embodiment delivers a highly customized experience for both consumers and merchants.

An embodiment provides merchants with unprecedented flexibility to self define and publish marketing campaigns that meet each merchant's individual needs. Merchants define their own messaging, unit price structure, quantity of units they want to offer, product or service availability dates down to an individual day or a specific time period during a day and weather conditions.

The low cost and flexibility of an embodiment delivers a self service marketing platform to merchants and provides an immediate ROI given the financial model is one where the consumer does not pay up front for products and services which significantly differentiates the invention from traditional DOD sites; instead the consumer pays the merchant directly at the time the product or service is delivered or used. As a result, the first financial transaction goes directly to the merchant's bottom line avoiding any delay in payments for the merchants and typical DOD site holdback scenarios are eliminated.

For merchants, a principal object of an embodiment is to provide a more dynamic merchant-centric self-service platform driven by automated decisioning processes with operational advantages over the related art.

Additional operational advantages and differentiators from related art include:

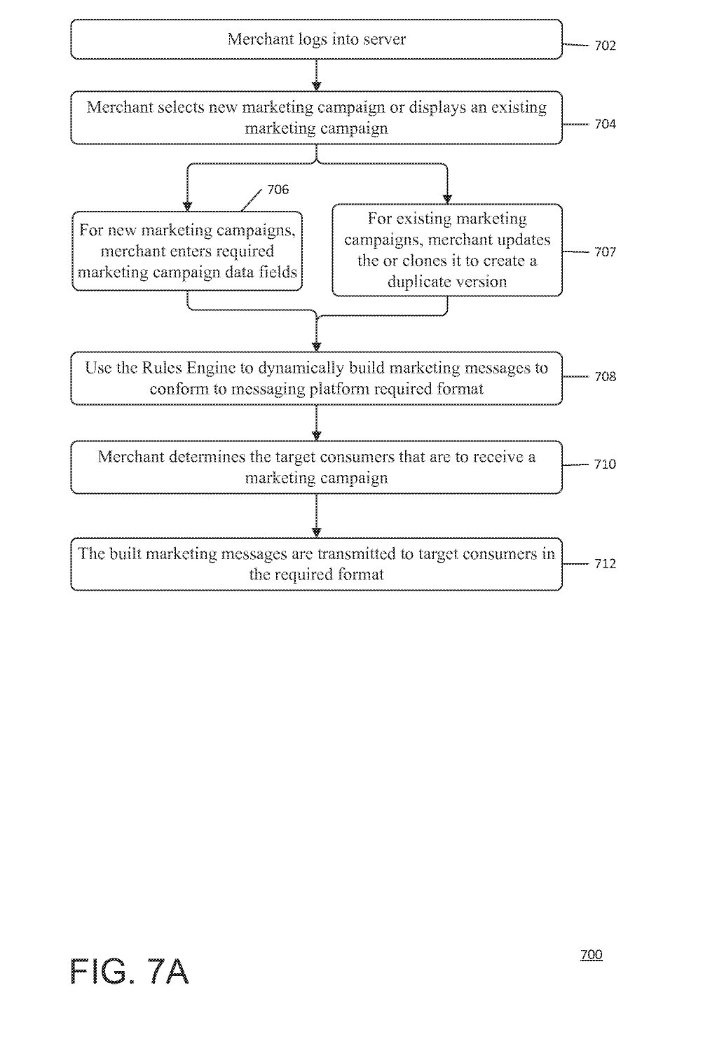

Merchant controls messaging (see FIGS. 6-7)—Merchant has full control to develop marketing messaging and publishing the same using sophisticated automated processes and self-service tools encapsulated within an embodiment. As merchant enters marketing message information, marketing messages are dynamically built.

Merchant controls pricing and timing—product and service price structure is defined by the merchant differentiating the invention from related art. Merchant can tailor their price structure and discounting based on their unique business needs and product and service availability.

Merchant controls timing and availability—merchants define when offered products and services are available for purchase down to 15-minute increments. Marketing campaigns can have a life of 1-day and only during specific times during that day or may span multiple days and multiple times per day. Unlike prior art, merchants can manage their business and ROI by excluding specific primetime dates and time frames (e.g. weekends and prime meal times).

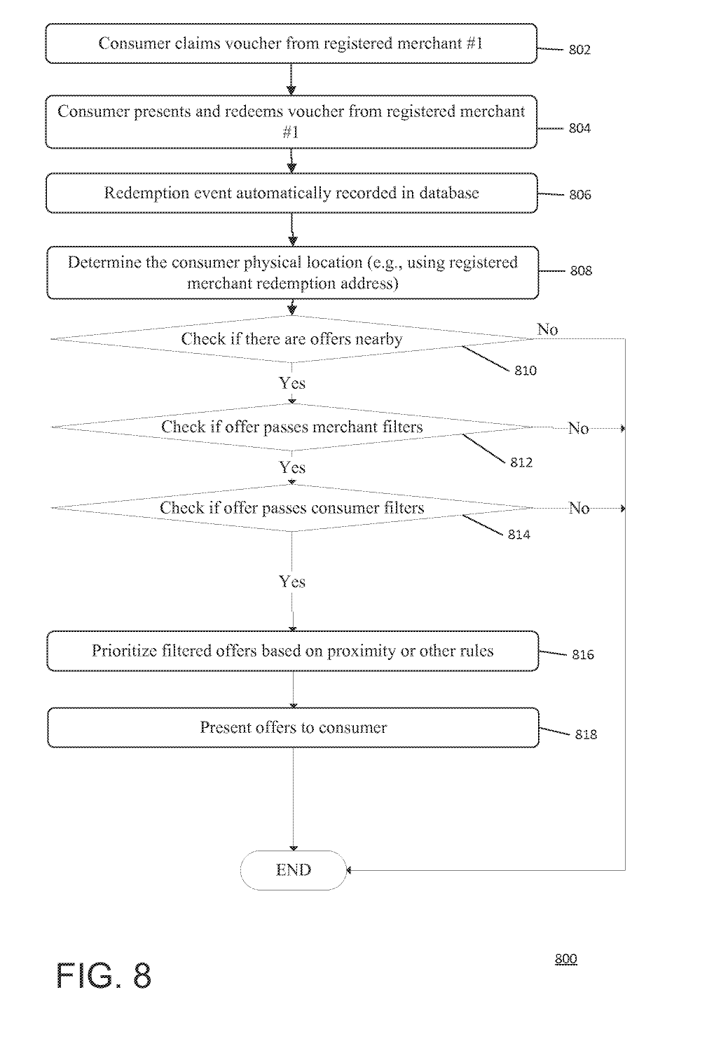

Automated location based cross marketing (see FIGS. 8-10)—merchant can publish marketing campaigns using the platform's automated location based marketing services targeting consumers who are known to be in the general area of the merchant. For example, consumer is at merchant #1's location and redeems a voucher. Merchant #2 can pre-publish an offer that is automatically pulled and delivered to the consumer if consumer redeems another merchant's voucher within a defined distance from merchant #2.

Merchant controls quantity offered—Small unit quantity can be offered—merchant has control over how many units they want to offer for sale and the maximum any one person can claim. Merchants are no longer required to offer high unit quantities for extended periods of time.

Merchant receives an immediate increase in ROI—a key differentiator with the invention is consumers pay the merchant directly which is different from prior art models where consumers pay the third party DOD site and the DOD site remits net of DOD fees (and holdbacks) to the merchant over a prolonged 30-60 day period after consumer receives merchant product or services. With an embodiment, merchant achieves an immediate increase in ROI on the very first sale and no longer has to wait 30-60 days to be paid after their product or service is delivered.

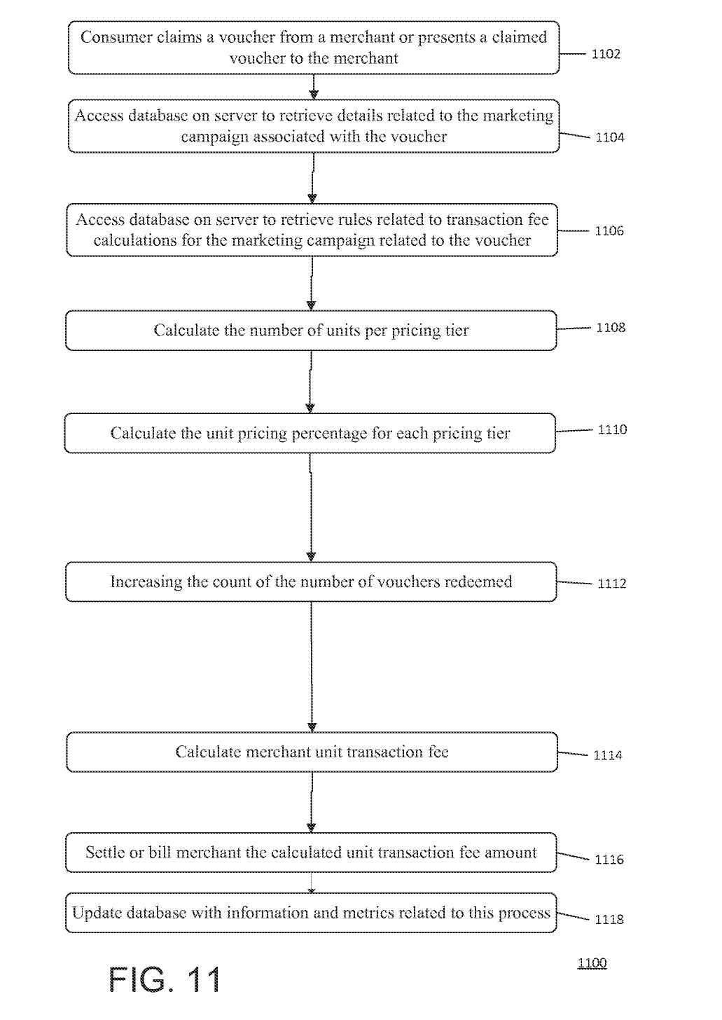

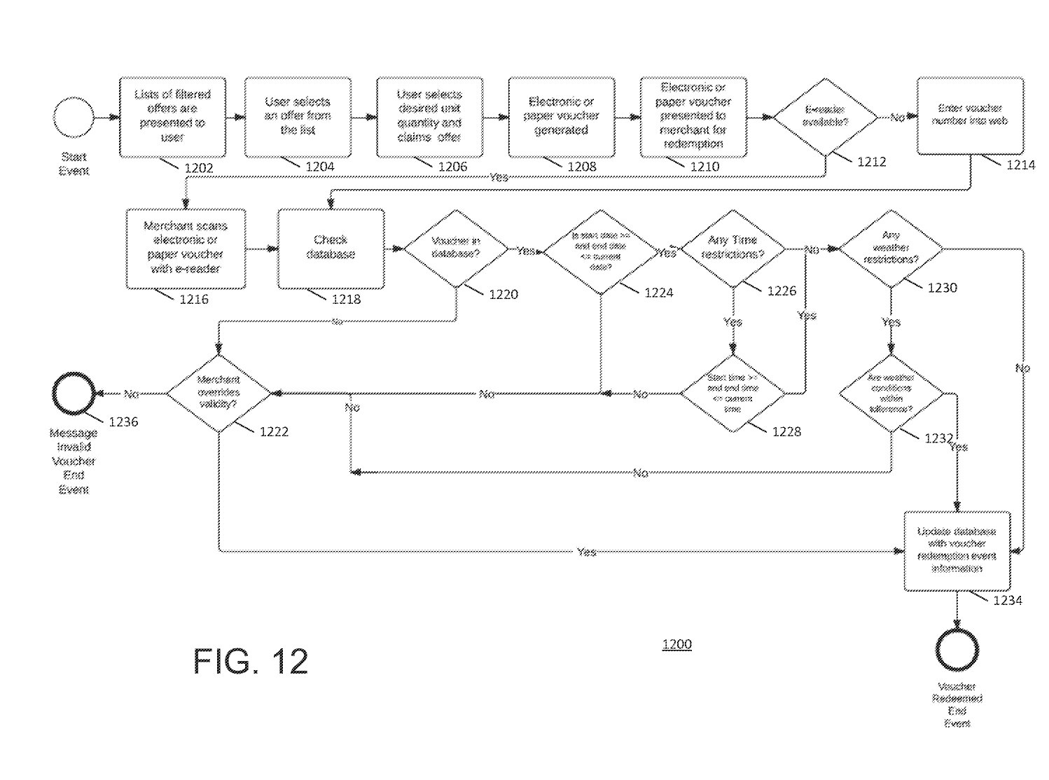

Merchant Transaction Fee Processing (see FIGS. 11-12)—method provides configurable and flexible technology, rules, and processes for calculating and collecting minimum transaction fees from merchant for published marketing campaigns and vouchers redeemed by merchant and the offsetting of minimum transaction fee by the amount of redeemed voucher transaction fee.

Target market flexibility—merchant has flexibility to market to their private client contact lists differently than social media prospects. Merchant can upload their private client list and launch marketing campaigns to their private label target audience differently than social media prospects. The result is an increase on ROI given merchants can entice existing clients with offers that help ensure customer loyalty and help reduce the need to discount to get repeat business.

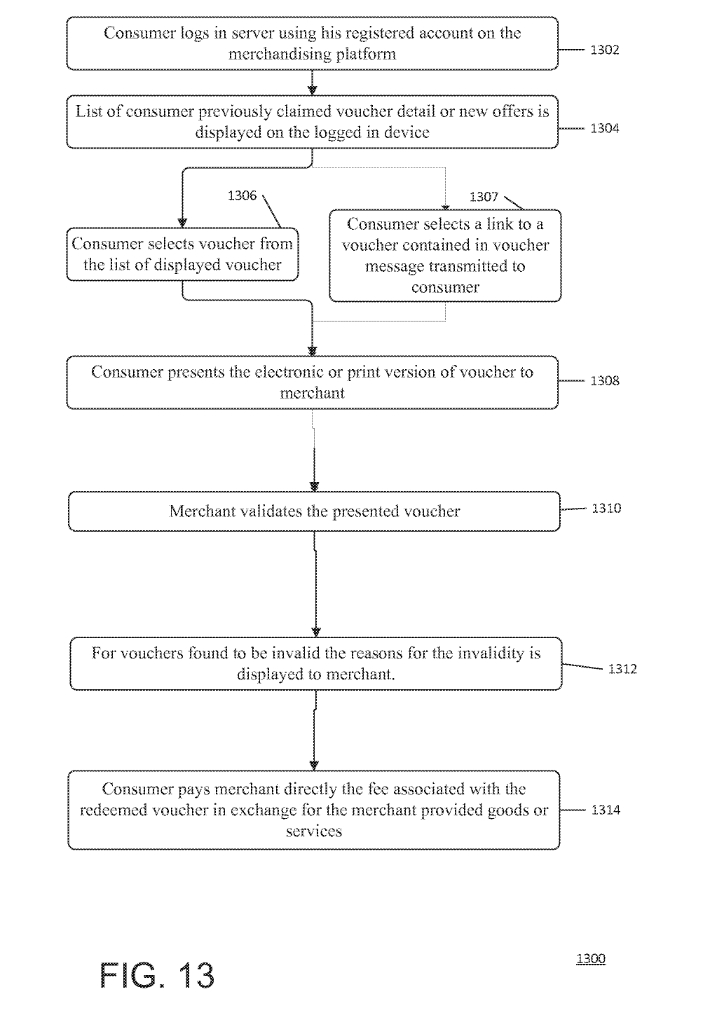

Automated voucher generation, validation, and redemption (see FIGS. 13-15)—method provides a unique and flexible merchant and user experience with respect to voucher generation, management and redemption.

On-demand Spot Marketing (see FIGS. 16-17)—An embodiment of an on-demand spot market method is designed to support merchants who are looking to maximize their ROI through marketing campaigns, developed using the invention, designed to attract consumers to purchase products and services from merchant during merchant defined down times or slow periods. This is a merchant on-demand self-service method where the merchant can develop and publish a spot market campaign real-time as the merchant identifies the need without the help of the vendor. For example, a car wash that has high fixed costs (lights, staffing, etc.) and low variable costs. The merchant's ROI is significantly impacted if the consumers are not at the carwash using the merchant's products or services. The merchant uses an embodiment of an on-demand spot market method to develop and publish immediate marketing messages focused on getting consumers to purchase products and service from the merchant during specific slow business periods. Spot market vouchers typically have a short life (minute and hours vs. days) and most likely will have one or more specific time of day constraints.

Low cost of ownership—merchant upfront and ongoing costs are significantly lower than the related art.

An embodiment of the invention utilizes automated processes that act real-time upon consumer defined filter criteria so that only desired marketing passing individual consumer filter criteria tests are automatically pulled and delivered to consumer for review, action and storage.

For consumers, one feature of an embodiment provides an improved, more dynamic, and user configurable shopping experience driven by automated decisioning processes with operational advantages over related art solutions.

Additional operational advantages and differentiators from prior art include:

Consumer does not pay up front for products and services—an embodiment provides a non-financially invasive solution to consumers where they do not pay for products and services upfront. Instead consumer receives an electronic voucher, which is then presented electronically or on paper to the merchant, and pays the merchant directly when the product or service is provided.

Consumer defines and pulls marketing messaging—an embodiment provides consumers with a direct means for defining, updating, changing or modifying their unique marketing profile and filters so that only requested merchant marketing material, of interest to the consumer, is pulled and delivered to the consumer. Consumer's marketing profile can encompass fixed and mobile distance from merchant, product category and sub categories, time, weather conditions, special events, and frequency of notifications.

Therefore, the merchandising platform is applicable to a number of target markets. Target markets include Time Sensitive Spot Market, Daily Deals, and National Accounts. Each has unique characteristics that are fully supported by an embodiment of the invention.

Time Sensitive Spot Market are marketing campaigns that are time sensitive. They are typically used by merchants to address immediate voids the merchant has in their business day. Spot market marketing campaigns may last one or more days but typically have a life of just a few hours on a specific day of the week. For example, a car wash has fixed costs (labor and building overhead) but Tuesday morning they find their ROI is low because they have no cars to wash during 8:30-9:30 am on Tuesday. At 8 am on Tuesday merchant can develop and immediately publish a marketing campaign targeted to bringing consumers in between 8:30 and 9:30 am that same day. Merchant can target the campaign at their private clients, social media or both.

Daily Deals are marketing campaigns that typically span more than one day and may or may not have time constraints. Daily Deals are typically used to generate new customers and to attract existing customers back to the business. While this may be similar in function to related-art DOD sites, it differs in many respects based on unique features found in an embodiment such as 1) merchant self-service functionality, 2) merchant's ability to support small unit quantity, 3) merchant defines and manages pricing, 4) merchant manages availability date and time of day, 5) merchant manages multiple pricing structures, 6) merchant manages publishing, a marketing campaign can be published immediately or scheduled to be automatically published at a future date and time and 7) merchant defines their target market.

National Accounts are large regional or national firms doing business online, in retail storefronts, or both (e.g. Wal-Mart, BestBuy, Target, etc.). The wealth of unique consumer shopping information maintained in the inventions database is of great interest to national accounts. National Accounts can query the inventions database and profile specific consumer shopping preferences and determine by zip code, city or region or product or service category specifically what consumers are looking for. National Accounts can craft marketing campaigns targeting specific consumer groups or market niches and publish their marketing campaigns to the platform database for immediate or scheduled delivery of the national account marketing campaign directly to consumers looking for the specific product or service offered by the national account. For example, Wal-Mart is getting ready to launch their Labor Day ads. They query the invention's database and identify over 3,000 consumers in a region that are looking for a 60-inch TV. Wal-Mart can download the SKU for 60 inch TV that is to appear in their Labor Day ad to the platform database and once the SKU is downloaded, the 3,000 consumers looking for 60-inch TV's will automatically pull the marketing information based on consumer filter rules to one or more consumer devices.

FIG. 6 illustrates an exemplary flow diagram of a marketing message dynamic generation and distribution process according to an embodiment.

Marketing message dynamic generation and distribution process 600 provides a method for automatically and dynamically building marketing messaging real-time for various messaging platforms as the data entry process occurs. Data entry can be done via voice, gesture, or typed (e.g., through the various input interfaces provided by the input interface 493). Messaging may be dynamically built, and visually viewable, as the data entry occurs for all popular messaging platforms using the technical constrains of those unique platforms. Example platforms include social media sites such as Facebook, Twitter, and Instagram and more open standard platforms such as email, push notification, and SMS text messaging.

Process 600 starts with the merchant logging on to the web or mobile platform 602. In an embodiment, the marketing message generation module 401 at the merchant device 400 may log into the marketing message generation module 301 at the server device 300 (e.g., a web browser or application on the merchant device 400 that directly outputs the interface sent by the server device 300).

Next, the merchant enters the required and/or optional marketing message data fields 604. For example, a marketing message represents an announcement of the corresponding marketing campaign that the merchant is attempting to push using the merchandising platform. As such, the marketing message and the data fields may include information such as description of product of service, pricing, number of units available, retail and discount pricing options, availability dates and times and restrictions such as user age, gender, and weather conditions for the marketing campaign. Some of this information may be required or optional depending on the marketing campaign.

Next, as the merchant enters the data, the marketing message for each unique messaging platform is dynamically built 606.

In step 606, the marketing message generation module 301 may be used on the server device 300 to build one or more marketing messages. The marketing message generation module 301 may use the rule engine 321 to obtain the message generation rule for a platform stored in the platform rule database 311. In an embodiment, the marketing message generation may also be performed by the merchant device 400 by the marketing message generation module 401.

In an exemplary embodiment of step 606, during the data entry, a plurality of the data entered is used to automatically and dynamically generate marketing messages conforming to various messaging platforms including social media sites such as Facebook, Instagram, and Twitter; and SMS text message, push notification, and email. Target messaging platforms are configurable by user.

In decision diamond 608, the process 600 checks if the merchant has entered the last field required. If the last field has not been entered, the process returns to step 606 to continue to dynamically build the marketing message.

Next, the merchant may test the built marketing message for each messaging platform 610 if the last field has been entered. Messaging is tailored to and embodies the required format and limitations of the target messaging platform(s). The visual representation of the marketing campaign for the target-messaging platform is displayed on the screen, web, mobile device, or multi-media device prior to publishing.

In decision diamond 612, the process 600 checks if the merchant has completed the testing of the marketing message.

Next, the marketing message and campaign is published if the merchant has completed the testing of the marketing message in step 614.

FIG. 7A-7C illustrate exemplary flow diagrams of a marketing message dynamic generation and distribution process according to an embodiment.

Process 700 starts with the merchant logging on to the web or mobile platform 702. In an embodiment, the marketing message generation module 401 at the merchant device 400 may log into the marketing message generation module 301 at the server device 300 (e.g., a web browser or application on the merchant device 400 that directly outputs the interface sent by the server device 300).

Next, the merchant selects either creating a new marketing campaign or displaying an existing marketing campaign for editing 704 within the interface of the marketing message generation module 401.

Here, it is usually the intention of the merchant to generate a marketing campaign to registered consumers, general public, social media, and private clients to sell a product or service offered by the merchant.

Next, for new marketing campaigns, the merchant enters the required marketing campaign data fields 706. Alternative to step 706, for existing marketing campaigns, merchant updates the existing marketing campaign or clones it to create a duplicate version of an existing marketing campaign 707.

In an embodiment, the clone process creates a copy of an existing marketing campaign. The existing marketing campaign may be retrieved from the market campaigns databases 314 and/or 415. Merchants clone existing marketing campaigns to prevent having to create from scratch and enter common marketing campaign information data.

For both new marketing campaigns and cloned marketing campaigns, merchant may input and/or update certain required marketing campaign data fields. For example, a marketing message may represent an announcement of the corresponding marketing campaign that the merchant is attempting to push using the merchandising platform. As such, the marketing message and the data fields may include descriptive information such as description of product of service, fine print, and more detail description related to the product or service being offered or multi-level category description of the offer (e.g., “electronics/TV/Samsung/LED/60 inch”). The marketing message and the data fields may also include pricing, merchant location, or locations where the product or service is available, the target audience that is to receive the marketing campaign (e.g., registered users, one or more private contact lists, social media, or the general public), number of units available, retail and discount pricing options, availability dates and times, uploads an image representing the marketing campaign (e.g., an image of the merchants business, product, or service being offered), and restrictions (e.g., consumer age, gender, and weather conditions) for the marketing campaign. URL links or other pointers to third party systems such as OpenTable and reservation systems can also be incorporated into the marketing message as defined by the merchant. Merchant determines how long a marketing campaign is available which may be multiple days or as short as one hour. In an embodiment, some of this information may be required or optional depending on the marketing campaign.

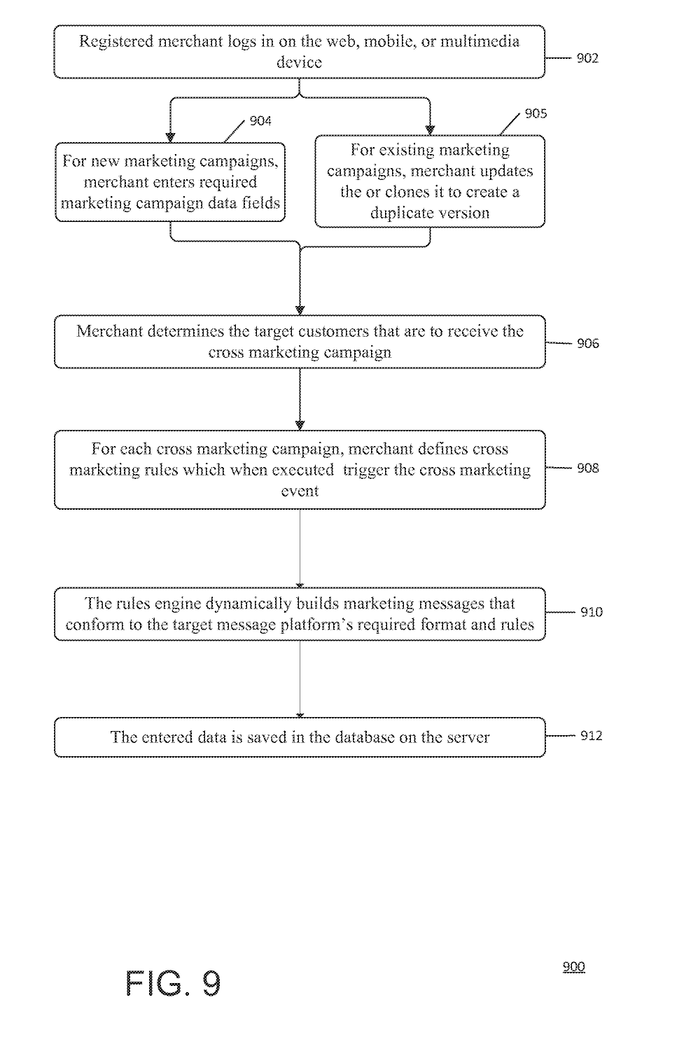

Further, merchant may also incorporate a proximity rule to facilitate cross-marketing (to be further discussed with respect to FIGS. 8-9) as part of the marketing message. Proximity rules allow merchant to automatically publish a marketing campaign to a consumer when they are within a defined distance, time, or other parameters from a merchant location as indicated in the marketing message. For example, merchant can publish a marketing message for a free cup of coffee that is to be sent to consumers only when consumer is within 0.25 miles from merchant's location. In another example, the marketing message may be sent to consumers if the consumer is within a certain time of travel to the merchant's location (e.g., taking into account waiting time for street lights if walking, taking into account speed limit and traffic signals and traffic conditions if driving). In an embodiment, third party applications may be used for the distance and time of travel calculations (e.g., Google Maps, Mapquest, etc.).

Next, the rules engine dynamically builds marketing messages that conform to the target message platform's required format and rules 708.

For each message platform, such as email, SMS, push notification, Twitter, Facebook, Instagram, etc., the various rules (stored in platform rule database 311) may be used to identify and apply weighting factors to key elements of the marketing message. For example, a platform rule may be based on the format, image, and length restrictions mandated by the target message platform. The platform rule may also provide instructions for formatting the marketing message, based on the standards for the target message platform and the weights applied to the key elements of the marketing message, so the marketing message contains the correct key elements of the marketing campaign and conform to the restrictions of the target marketing message platform.

For example, for the email message, there are few structure restrictions, and the rule engine 321 may format the email message by incorporating key elements of the marketing message into the email including UPL links, buttons and the image provided by the merchant. For the Twitter Tweet messages, the rules engine recognizes the various Tweet format and length restrictions and formats the Tweet using weighted key elements of the marketing message and without inclusion of the image.

A marketing message may be built for a plurality of messaging platforms for each new and cloned or updated marketing campaign. For example, the merchant enters all required marketing campaign data elements in step 706 and/or 707. The marketing campaign includes a description of product or service, an image, pricing, number of units available, retail and discount pricing options, availability dates and times, and restrictions such as user age, gender, and weather conditions for the marketing campaign. The marketing message is then built from following the platform rule for each of the desired platforms.

Target messaging platforms are configurable by the merchant and the consumer. Merchants can configure and publish marketing campaigns to all message platforms. Consumers, using a consumer device 500, can configure their consumer device to restrict receipt of marketing campaigns from one or more messaging platforms (e.g., consumer filter rule 512). For example, if consumer only wants to receive marketing campaigns via email and SMS, consumer accesses the consumer device and updates their account preferences on the device indicating they only want email and SMS marketing messages. In this case, if merchant publishes a marketing campaign using email, SMS, Facebook and Twitter message platforms, consumer will only receive the marketing message via email and SMS.

In an embodiment, each of the generated marketing messages for the various platforms is stored so that the marketing message may be reused without needing to regenerate the marketing message (e.g., when the marketing campaign is reused at a later time).

Next, merchant determines the target consumers that are to receive the marketing campaign 710.

In an embodiment, the rule engine 321 may generate a list of the target consumers according to suggestions from the databases. For example, the list may be generated from either or both of the merchant's preferences (e.g., merchant contact list database 414) or the consumers' preferences (e.g., consumer profile 511 and/or communication profile 514).

In an embodiment, the merchant determines the target audience, which can include the general public, registered consumers; one or more merchant defined contact lists or a plurality of general public, registered consumers, or defined contact lists. In one example, merchant may decide to publish the marketing campaign only to one of the merchant's contact lists. As such, when marketing campaign is published, it is distributed to only the names or businesses defined in the selected contact list.

However, in one embodiment, the general public and registered consumers can view the marketing campaign online on a consumer device 500 (e.g., using the marketing message display module 501, which may directly view the marketing campaign on the sever device 300). For example, the general public and registered consumers may browse to the merchandising platform website, which has a list of published offers for viewing, and the consumer is able to select or filter those marketing campaigns that are of interest.

In another embodiment, the merchant may determine if the marketing campaign is to be visible to those consumers other than the target consumers. Merchant can mark the marketing campaign as private, in which case the marketing campaign will only be visible by the target audience (e.g., only to the contact list generated) and is not visible to anyone outside the target audience. For example, the merchant may be interested in publishing the marketing message for distribution only to a target market and restrict anyone outside the target audience from viewing the marketing campaign. By selecting make private, merchant is able to restrict access to the marketing campaign to anyone that did not receive a marketing message.

Next, the built marketing messages are transmitted to the target consumers using in the required format 712.

For each unique consumer in the generated list of target consumers from step 710, rule engine 321 further accesses the customer filter rules database 313 to determine which messaging platform or platforms are to be used to send the marketing message to the consumer. For example, the customer filter rules database 313 includes preference information (corresponding to the consumer filter rules 512) that was collected directly from the consumer. As such, one or more preferred messaging platform for receiving the marketing message is able to be determined for each consumer.

In another embodiment, the merchant is able to set a preferred messaging platform for each consumer that the merchant added through its own contact list. For example, the merchant may have collected email addresses from its own list of consumers. As such, the merchant is able to add these consumers with email as a communication preference even though the consumers themselves had not registered with the merchandising platform yet. In one embodiment, this option may not be available depending on local laws or other restrictions.

Further, in one embodiment, the merchant is also able to set a preferred, acceptable, and/or restricted messaging platform for its market campaigns. For example, if the merchant does not wish to send its marketing campaign through Facebook or Twitter (e.g., because it is broadcasted to many people via news feeds and the merchant wishes to keep a marketing campaign more private or with slower dissemination), it may restrict such messaging platform for transmission of the marketing message.

In an embodiment, the customer filter rules database 313 is further accessed to determine if the category and sub-categories of the product and service being offered in the marketing campaign is of interest to the consumer before transmitting to the consumer. In another embodiment, it is further determined if the proximity, time of travel, or other parameters from consumer's device 500, as defined by the individual consumer, to a merchant location defined in the marketing message is within acceptable range; if it is, the marketing message is then sent to the consumer using the messaging platforms defined by the consumer in the customer filter rule database 313.

FIG. 8 illustrates an exemplary flow diagram of a location based cross marketing process according to an embodiment.

Location based cross marketing process starts with the consumer claiming a voucher from a registered merchant 802.

In an embodiment, the consumer may, through a marketing message sent to a messaging platform (as discussed with respect to FIGS. 6-7 above) or by browsing merchandising platform for marketing campaigns via a server device 300, claim a voucher for a marketing campaign.

For example, this process may involve the consumer selecting to claim a voucher for a product or service offered by a merchant in a marketing campaign. The corresponding process at the consumer device 500 (e.g., the location based cross marketing module 502) or the server device 300 (e.g., the location based cross marketing module 302) may read the data related to the marketing campaign from the corresponding database (e.g., the market campaigns database 314). The process may further verify the product and/or service being claimed for the marketing campaign against the rules and restrictions for the marketing campaign (e.g., date and time parameters, weather conditions, etc.).

Once the marketing campaign is read and verified, a voucher is generated for the consumer for the marketing campaign. For example, the merchandising platform, through the voucher generation module 304, may generate a voucher containing a unique voucher number (e.g., using a unique voucher number algorithm). The unique voucher may also include various reference links retrieved from the database (e.g., links to OpenTable for a restaurant, merchant's websites, or appointment scheduling applications). Further details on voucher generation will be discussed below with respect to FIGS. 13-15.

After voucher generation, the voucher and the associated reference data (e.g., user information, date and time stamps, etc.) are recorded in the database (e.g., the voucher database 315). Vouchers may be sent to the consumer based on the communication rules and preferences defined by the consumer (e.g., SMS, email, push notification, etc.). Vouchers may also be retrieved and viewed electronically from a mobile and/or web device (e.g., consumer device 500) by logging into the merchandising platform.

Next, the consumer presents and redeems voucher from the registered merchant 804.

In an embodiment, the user may present an electronic voucher (e.g., the consumer device 500 accessing a copy of the voucher) or a paper voucher (e.g., printout) to the merchant for redemption.

The merchant may use a validation tool or process on the merchant device 400 to validate the voucher. For example, the validation tool may access the sever device 300 to determine if the voucher is valid based on one or more of the date, time of day, weather conditions, age and/or gender of consumer, or other restrictions on the redemption of the voucher for the marketing campaign. In an embodiment, the validation tool may scan the voucher's QR or bar code, or alternatively accepts data entry of the voucher number, accesses the database to confirm voucher is valid and to determine if voucher has been previously redeemed, has expired, or can be actively redeemed based on merchant's defined restrictions.

In an embodiment, the merchant may manually allow a redemption of the voucher even if the voucher has been previously redeemed, has expired, or is presented to merchant outside merchant defined restriction rules. For example, the merchant may manually override a determined invalid voucher by issuing an acceptance using the merchant device 400.

Next, the redemption event is automatically recorded in the database 806.

Upon successful redemption of the voucher, the redemption event is recorded in the database (e.g., the vouchers database 313, the vouchers database 413, and the vouchers database 513), including the date/time of the redemption, who redeemed the voucher, the exact merchant location where the redemption took place, and other information.

Next, the consumer's current physical location is determined 808.

In an embodiment, the location of the consumer may be determined by a number of ways as now known or may be later derived, including but not limited to global position system, cell tower triangulation, and other methods (e.g., through the relevant geolocation functions of the consumer device 500). In a preferred embodiment, the location of the consumer may be determined as a known position of the merchant's location at redemption. For example, whether the redemption event is successful or not, the use of the merchant device 400 to validate the voucher would indicated that the consumer is physically located at the merchant's location. As such, the consumer's location could be known even if the consumer device does not support geolocation functions or such functions have been turned off (e.g., for privacy reasons).

Next, in decision diamond 810, the database (e.g., market campaigns database 315) is checked to determine if there is any cross marketing offers available to present to consumer. If yes, the process 800 proceeds to step 812.

Next, in decision diamond 812, the cross marketing offer is checked to see if the offer passes the merchant filters. If yes, the process 800 proceeds to step 814.

Next, in decision diamond 814, the cross marketing offer is checked to see if the offer passes the consumer filters.

With respect to decision diamonds 810, 812, and 814, these decisions may be made in alternate or simultaneous orders. In a preferred embodiment, the merchant filters (e.g., merchant rules set for a marketing campaign as discussed above) and the consumer filters (e.g., consumer filter rule 512) are each checked separately to see if the cross marketing campaign is acceptable to present to the consumer.

Next, the cross marketing offers are prioritized based on proximity or other rules 816.

If there are one or more merchant cross marketing offers available, the cross marketing offers may be filtered by merchant and user defined proximity (distance) or other rules. For example, the cross marketing offers may only be selected if the respective offers are within a threshold distance or a threshold time of travel of the consumer. As such, this creates a unique consumer experience driven by business rules defined by a merchant and consumer; no two consumers will necessarily have the exact same experience or be presented with the same cross marketing offers on the same day or time, for the same merchant.

In an exemplary process, the merchant may first publish a “Free Coffee” cross-marketing offer, which is to be presented to any consumers who redeem a voucher within 0.25 miles of merchant's location. Published offer is recorded in the database. In this case, the consumer's uniquely defined filter rule is set to allow the pulling (notification) of cross marketing offers for “Coffee” if user is within 1 mile of a merchant (consumer rule). As such, in this case, the consumer would receive the cross-marketing offer if they were within 0.25 miles of the merchant offering free coffee.

Next, the offers are present to the consumer 818.

In an embodiment, cross marketing offers are presented to the consumer based on the consumer's defined preferred communication method as discussed above. For example, cross marketing offers passing both merchant and user rules are automatically delivered to a specific user using individual user defined delivery methods such as email, push notification, Facebook, Twitter, SMS text message, etc. If multiple offers result, messaging may be consolidated.

In an example of the process 800, a consumer redeems a voucher for new tires at one of Joe's Tire Store locations on a Tuesday at 10 am. Joe's Tire Store will verify the voucher either electronically by scanning the voucher or manually entered key voucher data. As part of the verification process Joe's Tire Store locations where the voucher can be redeemed are displayed. If Joe's Tire Store has multiple locations merchant identifies the location where the voucher redemption attempt is occurring. This identification process clearly identifies the merchant's location address without the need to use GPS or cell tower triangulation. If Joe's Tire Store does not have multiple locations the location verification step is not required as the store location is known.

Continuing with the example, Bill's Café develops and publishes a cross-marketing campaign designed to attract consumers to come to Bill's Café for a free cup of coffee if the consumer is within 0.5 miles of Bill's Café between 8 am and 11 am on a Tuesday.

Continuing with the example, next, the attempted redemption of a voucher by Joe's Tire Store using the voucher redemption process triggers cross marketing rules to be executed. Cross marketing rules access the consumer filter rules for initial screening to determine if consumer wants to receive cross marketing messages and if so is Bill's Café within consumers acceptable distance and/or estimated travel time parameters. Cross marketing rules access the cross marketing campaign database and determine that Bill's Cafe, that happens to be located within 0.5 miles of one of Joe's Tire Store's locations has a cross marketing campaign offering a free cup of coffee. Data elements associated with Bill's Café's cross marketing campaign for the free cup of coffee stipulate that only consumers redeeming a voucher at a merchant that is within 0.5 miles or within an estimated 20 minute travel time of one of Bill's Cafe's locations on a Tuesday between the hours of 8 am to 11 am should receive Bill's Café's free coffee cross marketing message. In this example the consumer passes the merchant's cross marketing rules and is a candidate to receive a marketing message for Bill's Café's free cup of coffee.

Further continuing with the example, next, consumer filter rules 511 are executed to determine if the consumer is interested in receiving Bill's Café's free coffee marketing message. In this example, the consumer filter rules 511 indicate the consumer is acceptable to receive cross marketing coffee marketing messages on Tuesday at 10 am (the day and time consumer attempted the voucher redemption at Joe's Tire Store). Consumer therefore will receive Bill's Café's free coffee marketing message using the type or types of marketing message platforms, such as email, Twitter and push notifications, etc. that the consumer defined in their consumer filter rules.

FIG. 9 illustrates an exemplary flow diagram of a location based cross marketing process according to an embodiment.

Process 900 starts with the merchant logging on to a merchant device 902.

In an embodiment, the marketing message generation module 401 at the merchant device 400 may log into the marketing message generation module 301 at the server device 300 (e.g., a web browser or application on the merchant device 400 that directly outputs the interface sent by the server device 300).

Merchant intends to create a narrowly targeted cross marketing campaign and associated marketing message and publish the marketing message to consumers passing merchant defined cross marketing campaign rules. Consumers receiving the marketing message may encompass one or a plurality of consumers who are in the process of redeeming a voucher stored in the voucher database 512.

To create a cross marketing campaign merchant selects either creating a new marketing campaign or displaying an existing marketing campaign for editing or cloning within the marketing message generation module 401 interface.

Next, for new marketing campaigns, the merchant enters the required marketing campaign data fields 904. For existing or cloned cross marketing campaigns merchant updates, alters or retains existing marketing campaign data fields 905.

In an embodiment, steps 904 and 905 are similar to steps 706 and 707 respectively as discussed with respect to FIG. 7.

Merchant enters or updates one or more additional data fields not normally required by non-cross marketing campaigns. Additional data fields are used by the merchants to restrict some consumers from receiving a cross marketing message. Additional data fields may include one or more of the following and additional restricting data fields as they are defined: distance and estimated travel time from consumer to travel by car or walking to one of merchant's locations relative to the location consumer redeemed a voucher, time of day, day of the week, campaign beginning and expiration dates, category and sub-category of product and service being offered, current weather conditions, etc.

Other campaign data fields entered or updated include: descriptive information for the product or service being offered, fine print and more detail description related to the product or service being offered, multi-level category description of the product or service such as “fast food/coffee”, pricing, merchant location or locations where the product or service is available, the target audience that is to receive the marketing campaign which in this case the target audience is cross marketing, number of units available, retail and discount pricing, availability dates and times, an image representing the marketing campaign such an image of the merchants business, product or service being offered and restrictions such as user age, gender, weather conditions and URL links to third party systems such as OpenTable and reservation systems can also be incorporated into the marketing message as defined by the merchant. Merchant determines how long a marketing campaign is available which may be multiple days or as short as one hour. Some of this information may be required or optional depending on the marketing campaign.

Next, merchant determines the target consumers that are to receive the cross marketing campaign 906. For cross marketing campaigns, the target consumers are identified and include any consumer meeting one or a plurality of merchant's cross marketing rules as defined in steps 904 or 905 discussed above. In addition, individual consumer filer rules (e.g. consumer filter rule 512) should be satisfied (similar to as discussed with respect to step 814) before the cross marketing campaign is sent to the consumer.

Next, for each cross marketing campaign, the merchant defines cross marketing rules which when executed trigger the cross marketing event 908.

Cross marketing rules may contain one or a plurality of: consumer being within a threshold defined distance or estimated travel time from one of merchant's locations, weather conditions, date, time of day, day of the week, and other parameters.

A data element of the cross marketing campaign are proximity rules that incorporate time and distance from consumer's location to merchant's location. For example: a rule may incorporate a test to determine if consumer is within 0.5 miles of one of merchant's locations and the travel time for the consumer to the closest merchant location is within 30 minutes.

In an embodiment, the voucher redemption process determines consumer's location based on the merchant's business location where the consumer redeemed a voucher and does not need GPS or cell tower triangulation to determine the location of the consumer. When the consumer redeems a voucher from the voucher database 512, the consumer's location is known.

Next, the rules engine dynamically builds marketing messages that conform to the target message platform's required format and rules 910.

For each message platform such as email, SMS, push notification, Twitter, Facebook, Instagram, etc., the merchant device 400 run rules to identify and apply weighting factors to key elements of the marketing message. Based on format, image and length restrictions mandated by the target message platform, rules provide instructions for formatting the marketing message, based on the standards for the target message platform and the weights applied to the key elements of the marketing message, so the marketing message contains the correct key elements of the marketing campaign and conform to the restrictions of the target marketing message platform.

A marketing message may be built for a plurality of messaging platforms for each new, cloned or updated marketing campaign. For example, the merchant enters all required marketing campaign data elements. The marketing campaign includes a description of product or service, an image, pricing, number of units available, retail and discount pricing options, availability dates and times, and restrictions such as user age, gender, and weather conditions for the marketing campaign. For the email message where there are few structure restrictions, the rules engine 321 formats the email message by incorporating key elements of the marketing message into the email including UPL buttons, and the image provided by the merchant. For the Twitter Tweet message, the rules engine 321 recognizes the various Tweet format and length restrictions and formats the Tweet using weighted key elements of the marketing message and without inclusion of the image.

As data entry occurs, or at the end of the data entry process, marketing messages are automatically and dynamically built and populated with pertinent information from data entry process for core messaging platforms using platform specific strict structure and field length constraints. For example, during the data entry a plurality of the data entered is used to automatically and dynamically generate visual and in memory marketing messages conforming to various messaging platforms including social media sites such as Facebook, Instagram, and Twitter; and SMS text message, push notification, and email.

Target messaging platforms are configurable by the merchant and the consumer. Merchants can configure and publish marketing campaigns to all message platforms. Consumers, using a consumer device 500, can configure their consumer device to restrict receipt of marketing campaigns from one or more messaging platforms. For example, if consumer only wants to receive marketing campaigns via email and SMS, consumer accessed the consumer device 500 and updates their account preferences on the device indicating they only want email and SMS marketing messages. In this case, if merchant publishes a marketing campaign using email, SMS, Facebook and Twitter message platforms, consumer will only receive the marketing message via email and SMS.

Next, the entered data is saved in the database on the server 912.

The marketing campaign data may be saved to the cross marketing campaign database 314 to be launched by a separate process.

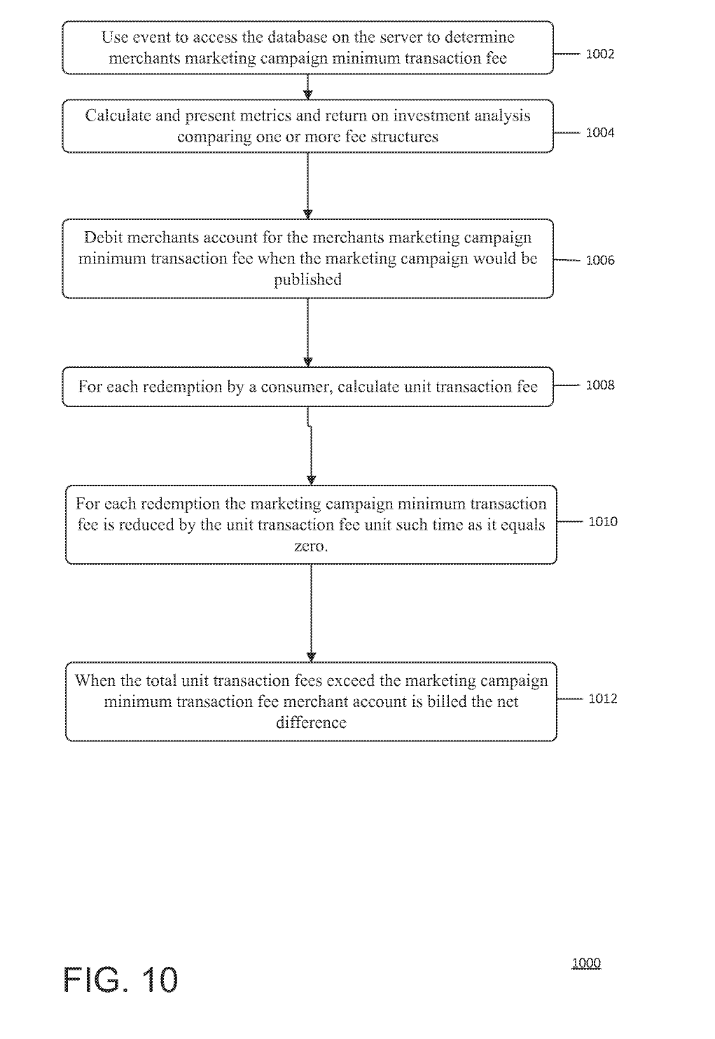

FIG. 10 illustrates an exemplary flow diagram of a merchant transaction fee processing process according to an embodiment.

In an embodiment, payment processing method differs significantly from related art. With the related art models, the consumers pay the deal-of-the-day sites (e.g., merchandising platforms) upfront for products and services. With the embodiment, the consumers do not pay upfront nor pay to the deal-of-the-day sites for merchant products and services; instead, the consumers pay the merchant directly at the time the product or service is provided by merchant to user. As a result, an immediate ROI is realized for the merchant on the first completed transaction.

Embodiments of the merchant payment model may encompass a Marketing Campaign Minimum Transaction Fee Merchant Transaction Fee, Target Transaction Fee Percentage, and a Unit Transaction Fee per redeemed voucher.

With respect to the Marketing Campaign Minimum Transaction Fee (MCMTF), this fee represents the minimum transaction fee merchant will be charged to publish a marketing campaign. The MCMTF is configurable by merchant and is collected from merchant at the point of publishing and may vary by merchant based on type of business and target market segment, merchant geographical location, size of registered merchant, merchant user base, category or sub-category of product being offered, and number of units being offered. When a voucher is redeemed, the MCMTF is reduced by the Unit Transaction Fees associated with the redeemed voucher until it is reduced to zero at which time Unit Transaction Fees in excess of the MCMTF are billed to merchant.

For example, for a Minimum Campaign Transaction Fee of $20, before the merchant is able to publish a marketing campaign merchant will pay a minimum transaction fee of $20.

With respect to the Target Transaction Fee Percentage, the target transaction fee percentage is based on merchant selling the majority of the units offered for sale for a marketing campaign.

For example, for a Target Transaction Fee Percentage of 25%, if redeemed voucher has a unit price of $100 merchant will pay a $25 transaction fee.

Pricing Tiers may be calculated for each unique marketing campaign. The number of pricing tiers is determined by dividing the total number of units being offered by the specific marketing campaign by the system configurable number of target tiers.

For example, a total of 100 units being offered and the invention configured tier structure is 4. This results in 4 pricing tiers being created with 25 units in each tier.

In Unit Transaction Fee, the pricing for each tier is determined by using a configurable weighting factor and a configurable Target Transaction Fee Percentage. The goal is to weight the percentage higher in the initial tier and scale it down in subsequent tiers so that if most units offered for sale are sold the average transaction fee percentage collected approximates the Target Transaction Fee Percentage.

For example, with a Target Transaction Fee Percentage of 40% and weighting factor of 20% and based on an example of 100 units being offer with 2 tiers, Tier 1 percentage may be 48% ((target transaction fee percentage*weight factor)+target transaction fee percentage) and Tier 2 percentage may be 32% ((target transaction fee percentage−(target transaction fee percentage*weight factor).

Referring to FIG. 10, process 1000 may start with using an event to access the database on the server to determine merchants marketing campaign minimum transaction fee 1002.

In an embodiment, the start event for starting process 1000 may involve a defined date and time (e.g., a closing date every month for a merchant or a specific marketing campaign, a start or end date of a marketing campaign, a creation of a new marketing campaign), an automatic or manual activation of the process 1000 (e.g., at a termination of the merchant's account with the merchandising platform), or other events.

Next, optionally, calculate and present metrics and return on investment analysis comparing one or more fee structures 1004.

In an embodiment, the merchant may select between one or more of the available payment model as discussed above. Depending on the setting of the merchandising platform and/or a contract with the merchant (e.g., only selected payment model maybe available to the merchant depending the types of product/services, volume of transactions/vouchers expected, and other conditions).

Next, the merchant's account is automatically debited with the minimum transaction fee for a marketing campaign when the marketing campaign would be published 1006.

In an embodiment, the marketing campaign is automatically published only when verification of payment occurs. As such, the merchandising platform may be able to better control the legitimacy and quality of a marketing campaign as a merchant may only start a marketing campaign when a payment occurs (e.g., for new, non-established merchants who are not verified).

Next, for each redemption by a consumer, the unit transaction fee is calculated 1008.

In an embodiment, the unit transaction fee may be selected from one or more of the available payment model as discussed above.

Next, for each redemption the marketing campaign, the minimum transaction fee is reduced by the unit transaction fee unit such time as it equals zero 1010.

Next, when the total unit transaction fees exceed the marketing campaign minimum transaction fee, merchant account is billed the net difference 1012.

In an embodiment, if the merchant has additional funds in the merchant account, or if the merchant has paid the minimum transaction fee for another marketing campaign that is not depleted, the merchant account or the minimum transaction fee for another marketing campaign may be deducted as payment for the total unit transaction fees for the present marketing campaign.

FIG. 11 illustrates an exemplary flow diagram of a merchant transaction fee processing process according to an embodiment.

As discussed above, an embodiment's payment processing method differs significantly from the related art. With the related art models, consumer may pay the related art site (e.g. deal of the day, etc.) upfront for products and services. The related art sites collect money from the consumer and pay merchant weeks and sometimes months after merchant has provided products and services to consumer. With the invention consumers do not pay upfront for merchant products and services, instead consumers pay merchant directly to merchant at the time merchant provides the product or service to consumer. Since merchant is paid directly by consumer, merchant realizes an immediate return on investment on the first completed transaction with consumer and a stronger relationship results between the merchant and the consumer because the middleman, found in related art, is eliminated and the business transaction is directly between the merchant and the consumer.

The embodiment of merchant payment model encompasses one or a plurality of merchant subscription fee, marketing campaign minimum publishing fee, unit transaction fee, target transaction fee percentage, pricing tiers, and pricing tier weighting factor. A portion of these fees were discussed with respect to FIG. 10.

The merchant subscription fee represents a periodic subscription fee that is paid in whole or in part for a period of time such as monthly or annually.

The marketing campaign minimum publishing fee (MCMPF) represents the minimum transaction fee merchant is charged to publish a marketing campaign. The MCMPF is collected from merchant at the point of publishing and may vary by merchant marketing campaign based on the type of merchant business, target market segment (e.g., automotive), merchant geographical location, size of registered merchant, size of merchant consumer base, category or sub-category of product being offered and number of units being offered. When a voucher is redeemed or alternatively when a voucher is claimed, the MCMPF is reduced by the unit transaction fee associated with the redeemed or claimed voucher until the MCMPF is reduced to zero at which time merchant unit transaction fees in excess of the MCMPF are billed to merchant.

In an example, the monthly merchant subscription fee is $9.95. Marketing campaign minimum publishing fee is $20. Before merchant can publish a marketing campaign merchant must be current on their monthly subscription fee of $9.95. Merchant will pay the $20 marketing campaign minimum publishing fee each time merchant publishes a marketing campaign. The minimum transaction fee is calculated based on one or a plurality of factors such as overall revenue to merchant if all units are sold.

The target transaction fee percentage is the target transaction fee percentage paid by merchants for units redeemed or alternatively claimed by consumer. If there is just one pricing tier the transaction fee paid by merchant for each unit sold equals the dollar value of the unit sold times the target transaction fee percentage. If there are more than one pricing tiers, the target transaction fee percentage is scaled so that units sold in the first pricing tier will be at a higher transaction fee percentage and units sold in subsequent pricing tiers are at a percentage equal to or lower than the target transaction fee percentage. If more than one pricing tier, the pricing tier transaction fee percentages are calculated using a pricing tier weighting factor.

Process 1100 starts when consumer presents a claimed voucher to merchant or alternatively claims a voucher from merchant 1102.

Here, the merchant transaction fee event may be calculated from when a voucher is claimed from the merchant (e.g., simultaneous to a voucher redemption event as discussed with respect to step 806).

In an embodiment, the consumer voucher claim process here is as discussed with respect to step 802.

Next, the database on the server is accessed to retrieve details related to the marketing campaign associated with the voucher 1104.

Here, the merchant transaction fee processing module 303 may retrieve the marketing campaign information from the database (e.g., market campaigns database 314 and voucher database 315).

Next, the database on the server is accessed to retrieve rules related to transaction fee calculations for the marketing campaign related to the voucher 1106.

Here, the specific rules may include marketing campaign minimum transaction fee percent, number of pricing tiers, pricing tier weight factor percent, and other rules.

Next, the number of units per pricing tier is calculated 1108.

In an embodiment, the number of units per pricing may be calculated as dividing total marketing campaign units offered in the marketing campaign by the number of pricing tiers resulting in a relatively equal number of whole units in each pricing tier.

In an embodiment, this step 1108 may be pre-calculated (e.g., when the marketing campaign is created) and the number of units per pricing tier may be retrieved as an information related to and stored with the marketing campaign.

Next, the unit pricing percentage for each pricing tier is calculated 1110.

In an embodiment, the unit pricing percentage for each pricing tier may be calculated by using the marketing campaign minimum transaction fee percent and the pricing tier weight factor percent retrieved from database to calculated unit transaction fee percentage for each pricing tier. If the number of pricing tiers is equal to one, unit pricing percentage equals campaign minimum transaction fee percent. If the number of pricing tiers is greater than one, unit transaction fee percentage is calculated using the marketing campaign minimum transaction fee percentage and the pricing tier weight factor percent retrieved from the database so that units sold in the first pricing tier are at a transaction fee percentage higher than the merchant campaign minimum transaction fee percentage and units sold in subsequent pricing tiers are at a percentage equal to or lower than the merchant campaign minimum transaction fee percentage so that if all units are sold the average unit transaction fee percentage paid by merchant equals the marketing campaign minimum transaction fee percentage.

In an embodiment, the unit pricing percentage for each pricing tier may be pre-calculated (e.g., when the marketing campaign is created) and retrieved as an information related to and stored with the marketing campaign.

Next, the count of the number of vouchers redeemed is increased 1112.

Here, the count of the number of vouchers redeemed is generally increased by one (1) if the consumer redeems the voucher for one instance of a product or service. However, the consumer may choose to redeem more than one instance of a product or service. In this case, the count may be increased by one (e.g., the count is tied to the number of consumers redemption if stipulated by the pricing model regardless of the number of product or service redeemed) or more than one (e.g., by the number of instances of the redemption).

In another embodiment, in cases that the merchant device 400 is unable to immediately access the server device 300, the count may be temporarily stored in the merchant device 400 (e.g., with vouchers database 413 or merchant marketing campaigns database 415) and transmitted to the server device 300 when connection is reestablished. As such, the count may be increased by more than one when transmitted to the server device 300.

Next, the merchant unit transition fee is calculated based on the cumulative count for the redeemed vouchers for the marketing campaign 1114.

In an embodiment, the merchant unit transaction fee calculation may encompass determining which pricing tier the cumulative count of vouchers falls and using the unit price of the product or services multiplied by the associated pricing tier percentage.

Next, the unit transaction fee is settled or billed to the merchant 1116.

For example, if the merchant paid an upfront minimum transaction fee amount, the calculated unit transaction fee is subtracted from the minimum transaction fee. If the minimum transaction fee has a zero balance, all unit transaction fees in excess of the minimum transaction fee balance is billed to the merchant.

Next, the database is updated with information and metrics related to the merchant transaction fee processing 1118.

Here, the billing information and various analytics associated with the marketing campaign may be saved to the database (e.g., market campaigns database 314).

In an example, the pricing tier for a marketing campaign is configured as 3. The target transaction fee percentage is configured as 10%. The pricing tier weighting factor is configured as 20%. Next, the merchant publishes a marketing campaign for 300 units valued at $100 per unit.

Since there are 3 pricing tiers, total units of 300 is divided by 3 resulting in 100 units per pricing tier. The value to merchant if all 300 units are sold is $30,000 and the total target transaction fee if all units are sold is $3,000 ($30,000*10%). With a target pricing tier percentage of 10% and a pricing tier weighting factor of 20%, rules are executed to configure the 3 pricing tiers so that initial units sold by merchant are at a higher transaction fee percentage with the average transaction fee if all units are sold equaling the target transaction fee percentage of 10%. Rules use the pricing tier weighting factor to calculate the transaction fee percentages for each of the 3 pricing tiers. In this case, the first pricing tier transaction fee percentage will be 12% (20% more than the target transaction fee percentage), the 2nd pricing tier transaction fee percentage is calculated to be 10%, and the 3rd pricing tier transaction fee percentage is calculated to be 8% (20% less than the target transaction fee percentage) equaling the target transaction fee percentage of 10% over all pricing tiers.

In this example if merchant sells only 50 units (1^{st} pricing tier) merchant will pay a unit transaction fee equal to 12% of the value of each unit sold. If merchant sells 110 units merchant will pay a unit transaction fee based on 12% transaction fee on the first 100 units and a unit transaction fee of 10% on the next 10 units.

FIG. 12 illustrates an exemplary flow diagram of a voucher generation, validation, and redemption process according to an embodiment.

The voucher generation, validation, and redemption process 1200 starts with presenting a list of published marketing campaign offers to the consumer 1202.

In an embodiment, a consumer may use a processing module on the consumer device 500 (e.g., marketing message display module 501 or voucher redemption module 504) to display a list of the published marketing campaign offers on the server 300 or to display a targeted marketing campaign offer sent directly to the consumer for being a part of a targeted list.

In a further embodiment, published marketing campaigns may be presented to consumer on their consumer devices 500 via notifications using various messaging platforms as defined by each unique consumer using consumer filer rules 512.

Next, consumer selects a marketing campaign offer from the list 1204.

In an embodiment, the marketing message display module 501 displays the marketing campaign offer. The consumer may review details related to a published marketing campaign using a consumer device 500.

Next, consumer claims one or more units of the marketing campaign offer 1206.

Consumer selects the number units for the product or service offered then triggers the claim process either through a keystroke or voice command (e.g., through input devices 593). In an embodiment, consumers do not need to pay up front for the product or service being claimed. Instead, they pay the merchant directly when merchant provides a product or service defined in a voucher to consumer. In an embodiment, consumers who do not redeem their generated vouchers (e.g., excessively over a certain threshold) may have restricted rights or other negative incentives to using the merchandising platform to encourage consistent redemption.

To complete the claim process, it may be required that the consumer be a registered consumer of the merchandising platform and log in on their consumer device 500. If consumer is not already a registered consumer, consumer is presented with necessary electronic data entry forms to register their account.

Next, one or more vouchers for the product or service offered are generated 1208.

The number of vouchers generated may be based on the number of units claimed by the consumer. Vouchers that are generated are stored in the vouchers databases 315, 413, and 513 and are accessible on either a consumer device 500 or merchant device 400 for review and retrieval.

Next, the consumer presents the merchant with either an electronic or a printed copy of a voucher for the product or service being offer by merchant for the associated marketing campaign 1210.

Next, in decision diamond 1212, it is checked to see if an e-reader is available, if yes, the process 1200 proceeds to the merchant scanning an electronic or paper voucher with the e-reader 1216. If no, the process proceeds to the merchant entering the voucher number manually 1214.

In an embodiment, vouchers may be embedded with barcode, quick response (QR) codes, or other types of coding as known now or may be later derived that allows a corresponding code reader to scan the code on the voucher for quick entry into the merchandising platform. For example, the merchant scans the presented voucher using either generic QR/barcode reader software located on a mobile or desktop device, a hardwired QR/barcode scanner or a provided proprietary QR/barcode reader software. Some merchant devices 400 may include a camera that is able to act as a scanner of QR/barcode.

In another embodiment, an electronic voucher may be sent wirelessly from the consumer device 400 to a merchant device 500 using various means such as direct transmission (e.g., bluetooth, infrared), through a network (e.g., through a LAN or the Internet), or by other means.

If the platform's bar code and QR reader technology is not available merchant can manually verify the validity of the voucher using the merchandising platform. The validation and redemption process is the same as the above with the exception that merchant will key or verbalize the voucher number found on the paper or electronic voucher into the merchant web or mobile portal. The entry process will validate the voucher using rules defined above and if valid allow merchant to redeem the voucher.

Next, the database is checked 1218 to determine if the voucher is in the database in decision diamond 1220. If the voucher is not in the database, the merchant has the ability to override the validity of the voucher 1222.

If the voucher is in the database, next, the marketing campaign rules and other associated validation rules are used to determine if the presented voucher is valid. This may include checking if the voucher redeemed within the valid date period 1224, the time period restrictions of the redemption 1226 and 1228, the weather restrictions 1230 and 1232.

In an embodiment, the voucher number printed on the voucher and also contained in the QR or bar code are used to access the voucher database (e.g., vouchers database 413) to retrieve key information related to a unique voucher and use the retrieved information to access associated marketing campaign rules (e.g., merchant marketing campaigns database 415) for the presented voucher. The validity process determines if the voucher was previously redeemed, has expired, is not yet redeemable based on merchant defined date and time rules, and look at any gender, merchant location, weather, and age rules to determine validity.

If the rules determine that the voucher is valid, the merchant may proceed to provide consumer with the product or services associated with the presented voucher and consumer may pay the merchant directly for the product or service provided. If rules determine that voucher is not valid, the merchant may be informed of the reasons why the voucher is deemed to be invalid. The merchant has the ability to override the reason and accept the voucher as valid in decision diamond 1222.

Next, the databases are updated to reflect the redemption process 1234.

Information may include the date, time, weather conditions, and location where the voucher was redeemed or was attempted to be redeemed. Additional information regarding the consumer attempting to redeem the voucher is recorded may include gender and birth date.

In an example, the consumer present paper or electronic voucher to merchant. Merchant uses invention's QR reader application to scan and validate voucher. If voucher found valid voucher will automatically be marked in database as redeemed and merchant will be notified of the same. If voucher found to be invalid merchant will receive a verbal or voice notification of the reason for the invalidity. Merchant then can decide to override the invalidity reason and proceed to redeem anyway. The override event and reason for the override is recorded in the invention's database for historical, report and analytics purposes.

FIG. 13 illustrates an exemplary flow diagram of a voucher generation, validation, and redemption process according to an embodiment.

In an embodiment, the voucher generation, validation, and redemption process automatically and dynamically generates electronic and print vouchers and the validation and redemption of the same. The consumer presents voucher to merchant when they are ready to receive merchant's product or service. Vouchers may be presented to merchant in electronic or paper form. In either case merchant will use tools provided by invention to validate the voucher and complete the redemption process.

Electronic voucher generated, or printed, are present by the consumer to merchant using any display device such as a mobile phone, website, wearable device, or tablet. Bar code or QR code on the voucher contains key information about the product and service being redeemed coded using an algorithm in an embodiment. To assist the merchant in the redemption process, the merchant may be provided with a bar code and QR reader application, which is seamlessly integrated with the platform's database on a server. A bar code and QR reader application run on the web and various mobile platforms such as iOS, Android, and Windows. Different from the related art, the bar code and QR reader technology can be installed on any merchant employee's mobile device or desktop device or can be access from the web thus eliminating the need for merchant to purchase and install third-party scanner hardware and technology. When the consumer presents voucher (electronic or paper) to merchant, merchant uses the platform's bar code and QR reader technology to scan the voucher. Technology will read the platform's database and retrieve information unique to the voucher, validate the voucher and request confirmation of the voucher redemption process.

The voucher generation, validation, and redemption process 1300 starts with the consumer logging into to the server 1302.

In an embodiment, the consumer may also log in using social media account, user id and password using the web, multimedia, or mobile device.

Next, a list of the consumer's previously claimed or new vouchers is displayed to the logged in consumer device 1304.

Next, the consumer selects a voucher from the list of vouchers 1306.

Alternatively, the consumer selects a link to a voucher contained in voucher message transmitted to consumer 1307.

For example, the voucher message may be transmitted to the consumer via push notification, SMS, Facebook, etc. as designated by the consumer.

The electronic version of the selected voucher is automatically generated and displayed on consumer's device 500 containing a unique encoded bar code or QR code. The consumer can alternatively print, email, and text (SMS) a representative version of the electronic voucher.

It is noted that, unlike the related art, the consumer does not pay upfront for the product or service; instead they pay the merchant directly when product or service is provided to the consumer.

In an embodiment, the server 300 may further access the offer database (e.g., marketing campaigns database 314) to determine to determine if the offer is still active, and the number of units user is trying to claim are still available. Further, the server 300 may check the consumer's profile (e.g., profile database 316) to ensure that consumer's age, gender or other criteria restrict user from claiming the offer.

Upon the successful claiming of an offer the respective offer voucher(s) is delivered to consumer via their defined preferred communication method. Voucher is also available online and via mobile and wearable device. The server 300 access database (e.g., consumer filter rules database 313) to determine the consumer's preferred communication method (email, SMS, social media, push notification, etc.). Once determined, the appropriate communications message is developed and sent to user via consumer's preferred communication method. The consumer's can also print the voucher and present the printed version of the voucher to the merchant.

Next, the consumer presents the electronic or print version of the voucher to the merchant 1308.

Next, in step 1310, the merchant validates the voucher presented by the consumer in step 1308.

Validation may encompass validating parameters such as date range, time ranges, distance, age, gender, and weather restrictions. Validation services include a plurality of validation options including the manual or verbal entry of the voucher number or scanning of bar code or QR code using provided or third-party means and processes. The validation event may be record in the database (e.g., voucher database 315) on the server 300.

In an embodiment, the rules engine 321 may access data stored in the inventions database and information found on the presented voucher to determine if the voucher is valid. A voucher may be validated by confirming a number of rules. Exemplary rules include:

Is voucher number valid? (Is voucher number found in the database)
Is voucher associated with a marketing campaign published by merchant that is redeeming the voucher?
Is voucher valid for the merchant location user is trying to redeem the voucher?
Is the redemption date within marketing campaign tolerance?
Is the redemption time within marketing campaign tolerance?
Are current weather conditions within marketing campaign tolerance?

If the rules engine 321 determines the presented voucher is valid, the merchant will receive a confirmation visual or oral message of the validity. The redemption process records the event in the platform's database for historical, reporting, and analytics purposes.

Next, if a voucher is found to be invalid, the reasons for the invalidity is displayed to the merchant 1312.

The validation event may be further logged to the voucher database 315 for future reporting and analytics. If rules engine 321 determines voucher is invalid the reason for the invalidity is displayed to the merchant, and the merchant in turn can then communicate the reason to the user.

Unlike the related art, the merchandising platform allows merchants to override the invalidity reason and redeem the voucher anyway. If overridden, the override is logged to the inventions database.

If the merchant was notified that the voucher is invalid, merchant can override the reason for the invalidity and proceed to redeem the voucher. The override and redemption process is recorded in the platform's database for historical, reporting and analytics purposes.

Next, the consumer pays merchant directly the fee associated with the redeemed voucher in exchange for the merchant provided goods or services 1314.

In an embodiment, the amount, date, time, and current weather conditions when redeemed is recorded in the database on the server.

In an example, the consumer receives marketing message from merchant for 40% of 4 new tires. The consumer reviews detail related to the product being offered and decides to claim the offer. The consumer selects a unit quantity of 1 then presses the claim button on the consumer device. The voucher claiming process asks consumer to either log into their account or if not already a registered user, create a new consumer account. If consumer is already logged into their account consumer will not be prompted to log in. When the claim process is completed a voucher for 40% off 4 tires is generated and stored in the consumer's voucher database. An email of an electronic copy of the voucher is also sent to the consumer's registered email address and alternatively links providing direct access to the voucher are sent to the consumer via push notification, SMS, Facebook, etc. as designated by the consumer.

It is noted that the consumer does not pay in advance for the product or service defined in the voucher.

Continuing with the example, when the consumer is ready to present voucher to merchant for 40% of window cleaning, the consumer can present an electronic version of the voucher using a consumer device to the merchant or alternatively print the voucher and present the paper voucher to the merchant. Merchant uses a QR/bar code scanner to scan either the paper or electronic version of the voucher or alternatively if merchant does not have tools to perform the scan process, merchant can manually or verbally enter the voucher ID on a merchant device to complete the validation process. If voucher is deemed to be valid, merchant will provide consumer with the 40% off on 4 tires and collect the amount due the merchant directly from consumer at point of service.

FIG. 16 illustrates an exemplary flow diagram of the on-demand spot marketing process according to an embodiment.

In an embodiment, the merchant may use an on-demand spot marketing process to create a focused on-demand spot marketing campaign for a narrowly focused timeframe and publish a on-demand spot marketing message to targeted consumers passing merchant's defined on-demand spot marketing campaign rules. The consumers receiving the on-demand spot marketing message may encompass one or a plurality of consumers targeted by merchant to receive the on-demand spot marketing message.

The on-demand spot marketing campaigns are used by merchants with fixed infrastructure costs with a desire to bring a steady customer inflow by attracting customers to their business during slow periods of time on a given day of the week, over a period of days and during a narrowly focused time of day.

For example, on a Tuesday at 9:45 am the owner of a car wash notices that there are no consumers at one of merchant's 3 business locations, in this example merchant's Lake Avenue location, waiting to have their car washed. Merchant's overhead costs at his Lake Avenue location are high, as much of which are fixed costs such as employee costs, utilities, etc. Anything merchant can do to immediately attract customers to stop by the Lake Avenue location for a car wash off-peak or slow times will help merchant increase revenue and cover overhead costs.

To immediately and proactively attract consumers, merchant, at 9:45 am on Tuesday, creates and publishes an on-demand spot marketing campaign for $5.00 off a deluxe car wash that is only valid Tuesday (today) between the hours of 10:00 am and 11:00 am. This on-demand spot marketing campaign is designed to immediately attract targeted consumers to visit merchant's Lake Avenue location between 10:00 and 11:00 am on Tuesday to get their discounted car wash resulting in new revenue to merchant and help mitigate merchant's fix infrastructure costs. After publishing the on-demand spot marketing campaign consumers can claim the $5.00 off voucher but must present the voucher at merchant's Lake Avenue location between 10:00 and 11:00 on Tuesday to get their $5.00 off on a deluxe car wash.

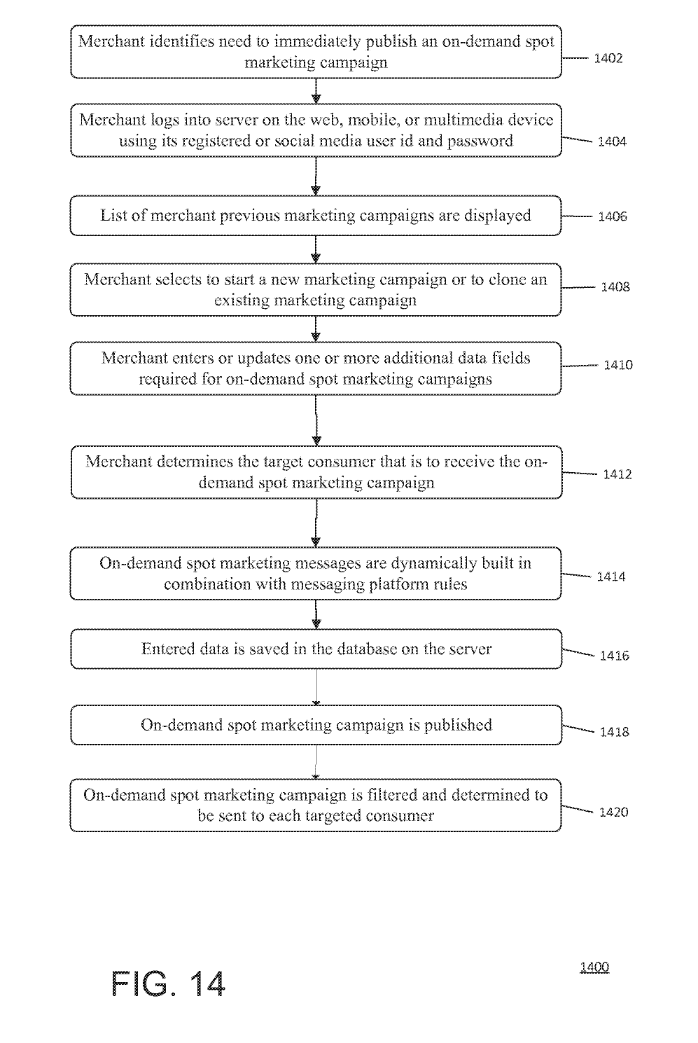

FIG. 14 illustrates an exemplary flow diagram of the just in time on-demand spot marking process according to an embodiment.

Process 1400 starts with the merchant identifying a need to publish an on-demand spot marketing campaign 1402.

In one instance, the merchant may decide to launch a just in time on-demand spot marketing campaign as described in the example above, where the merchant requires immediate publication of the campaign. In another instance, the merchant may decide that there may be a need to prepare an on-demand spot marketing campaign that may be launched in the future, in the event of certain conditions (e.g., when the weather is of a certain condition) or as needed by the merchant.

Next, the merchant logs on to the merchandising platform 1404.

In an embodiment, the on-demand spot market module 405 at the merchant device 400 may log into the marketing message generation module 301 at the server device 300 (e.g., a web browser or application on the merchant device 400 that directly outputs the interface sent by the server device 300).

Next, a list of the merchant's marketing campaign is displayed to the merchant 1406.

Next, the merchant selects to start a new marketing campaign or to clone an existing marketing campaign 1408.

To create a on-demand spot marketing campaign merchant selects either creating a new on-demand spot marketing campaign or displaying an existing marketing campaign for editing or cloning within the marketing message generation module 401 interface.

For a new on-demand spot marketing campaigns, the merchant enters the required on-demand spot marketing campaign data field. For existing or cloned on-demand spot marketing campaigns merchant updates, alters or retains exiting marketing campaign rules and data fields.

Next, merchant enters or updates one or more additional data fields required for on-demand spot marketing campaigns 1410.

Additional data fields are used by merchants to narrowly restrict the availability of an on-demand spot marketing campaign, which generally represents a narrowly defined date and time period.

Merchant may also identify a need to create and immediately publish an on-demand spot marketing campaign to attract consumers to come to one or a plurality of merchant business locations during a narrowly defined period of time which may be as short as 30 minutes in duration on a specific day of the week. On-demand spot marketing campaigns are short, time sensitive marketing campaigns designed to get consumers to merchant locations during off-peak or slow times during a business day.

For example, on a Tuesday at 9:45 am, the owner of a car wash notices that there are no consumers at one of merchant's 3 business locations. In this example, at the merchant's Lake Avenue location, nobody is waiting to have their car washed. Merchant's overhead costs at his Lake Avenue location are high; much of which are fixed costs such as employee costs, utilities, etc. Anything merchant can do to immediately attract customers to stop by the Lake Avenue location for a car wash off-peak or slow times will help merchant increase revenue and cover overhead costs.

To immediately and proactively attract consumers, the merchant, at 9:45 am on Tuesday, creates and publishes an on-demand spot marketing campaign for $5.00 off a deluxe car wash that is only valid Tuesday (today) between the hours of 10:00 am and 11:00 am. This on-demand spot marketing campaign is designed to immediately attract targeted consumers to visit merchant's Lake Avenue location between 10:00 and 11:00 am on Tuesday to get their discounted car wash resulting in new revenue to merchant and help mitigate merchant's fix infrastructure costs. After publishing the on-demand spot marketing campaign consumers can claim the $5.00 off voucher but must present the voucher at merchant's Lake Avenue location between 10:00 and 11:00 on Tuesday to get their $5.00 off on a deluxe car wash.

Other campaign data fields entered or updated may include: descriptive information for the product or service being offered, fine print and more detail description related to the product or service being offered, multi-level category description of the product or service such as “Auto/Car Wash”, pricing, merchant location or locations where the product or service is available, the target audience that is to receive the marketing campaign which in this case the target audience is on-demand spot, number of units available, retail and discount pricing, availability dates and times, an image representing the marketing campaign such as an image of the merchant's business, product or service being offered and restrictions such as user age, gender, weather conditions and URL links to third party systems such as OpenTable and reservation systems can also be incorporated into the marketing message as defined by the merchant. Merchant determines how long a marketing campaign is available which may be multiple days or as short as one hour. Some of this information may be required or optional depending on the marketing campaign.

Next, the merchant determines the target consumer that is to receive the on-demand spot marketing campaign 1412.

In an embodiment, marketing campaign rules may present merchant with target consumer suggestions from database (e.g., consumer filter rules database 313 and profile database 316). The merchant identifies and selects the target consumer, which can include the general public, registered consumers; one or more merchant defined contact lists or a plurality of general public, registered consumers or merchant contact lists.

For example, in one embodiment, the merchant decides to publish the marketing campaign only to one of the merchant's contact lists. When published the marketing campaign is distributed to consumers or businesses defined in the selected contact list. However, at the discretion of the merchant, the general public and registered users can also view the marketing campaign when logged into the merchandising platform.

In an embodiment, the merchant may also determine if merchant wants the on-demand spot marketing campaign to be visible only to the target consumer. Merchant can mark the marketing campaign as private, in which case the marketing campaign is only visible by the target consumer and is not visible to anyone outside the target consumer. For example, the merchant may be interested in publishing the marketing message for distribution only to a target audience and restrict anyone outside the target audience from viewing the offer. By selecting make private, merchant is able to restrict access to the on-demand spot marketing campaign to only the target audience.

Next, on-demand spot marketing messages are dynamically built in combination with rules that conform to the target marketing message platform's required format and rules 1414.

For each message platform such as email, SMS, push notification, Twitter, Facebook, Instagram, etc., the rules engine 321 may identify and apply weighting factors to key elements of the marketing message. Based on format, image and length restrictions mandated by the target message platform, rules provide instructions for formatting the marketing message, based on the standards for the target message platform and the weights applied to the key elements of the marketing message, so the marketing message contains the correct key elements of the marketing campaign and conform to the restrictions of the target marketing message platform.

A marketing message may be built for a plurality of messaging platforms for each new, cloned or updated marketing campaign. For example, the merchant enters all required marketing campaign data elements. The marketing campaign includes a description of product or service, an image, pricing, number of units available, retail and discount pricing options, availability dates and times, and restrictions such as user age, gender, and weather conditions for the marketing campaign. For the email message where there are few structure restrictions, the rules engine formats the email message by incorporating key elements of the marketing message into the email including UPL links, buttons and the image provided by the merchant. For the Twitter Tweet message, the rules engine recognizes the various Tweet format and length restrictions and formats the Tweet using weighted key elements of the marketing message and without inclusion of the image.

As data entry occurs, or at the end of the data entry process, marketing messages are automatically and dynamically built and populated with pertinent information from data entry process for core messaging platforms using platform specific strict structure and field length constraints. For example, during the data entry a plurality of the data entered is used to automatically and dynamically generate visual and in memory marketing messages conforming to various messaging platforms including social media sites such as Facebook, Instagram, and Twitter; and SMS text message, push notification, and email.

Target messaging platforms are configurable by the merchant and the consumer. Merchants can configure and publish marketing campaigns to all message platforms. Consumers, using a consumer device 500, can configure their consumer device to restrict receipt of marketing campaigns from one or more messaging platforms. For example, if consumer only wants to receive marketing campaigns via email and SMS, consumer accessed the consumer device 500 and updates their account preferences on the device indicating they only want email and SMS marketing messages. In this case, if merchant publishes a marketing campaign using email, SMS, Facebook and Twitter message platforms, consumer will only receive the marketing message via email and SMS.

Next, the entered data is saved in the database on the server 1416.

The marketing campaign data may be saved to the marketing campaigns database 314 (or a database for on-demand spot marketing) to be launched by a separate process.

Next, the on-demand spot marketing campaign is published 1418.

As discussed above, the merchant may select if the merchant wants to publish the on-demand spot marketing campaign immediately or schedule it to be automatically published at a later date and time. If the on-demand spot marketing campaign is to be published later, merchant has entered the date and time the on-demand spot marketing campaign is to be published. In each case, the on-demand spot marketing campaign may be published by the merchandising platform automatically.

Next, the on-demand spot marketing campaign is filtered and determined to be sent to each targeted consumer 1420.

For each unique consumer in the target consumer list, rules engine 321 may access the consumer filter rules database 313 to determine if the consumer should receive the on-demand spot marketing message and which messaging platform or platforms are to be used to send the on-demand spot marketing message to the consumer. Individual consumer filter rules database 313 is accessed to determine if the category and sub-categories of the product and service being offered in the marketing campaign is of interest to the consumer, and if it is, to determine if a proximity from consumer's device 500, as defined by the individual consumer in the consumer filter rule database 313, to a merchant location defined in the on-demand spot marketing message is within acceptable distance, estimated travel time range, or other criteria as defined by the unique consumer. If it is within the acceptable proximity, the marketing message is then sent to the consumer using one or a plurality of messaging platforms defined by the consumer in the customer filter rule database 313.

When consumer receives the on-demand spot marketing message they will have a narrow time to claim a voucher for the product or service offered in the on-demand spot marketing message and redeem the voucher at the designated merchant's business location.

In a preferred embodiment, a spot market method is designed to support merchants who are looking to maximize their ROI through marketing campaigns, developed using the merchandising platform, designed to attract consumers to purchase products and services from merchant during merchant defined down times or slow periods. This is a merchant self-service method where the merchant can immediately develop and publish a spot marketing campaign without the help of the vendor.

For example, a car wash that has high fixed costs (lights, staffing, etc.) and low variable costs. The merchant's ROI is significantly impacted if consumers are not at the car wash purchasing merchants products and services. The merchants use the spot market method to develop and publish immediate marketing messages focused on getting consumers to purchase products and service from merchant during specific slow business periods.

If the merchant in the example identifies a slow business period approaching at 8:30 am in a matter of minutes the merchant can develop and publish a spot marketing campaign targeted at attacking consumers to come to the carwash between 8:45 and 9:45 that same day. Spot market vouchers typically have a short life (minutes and hours vs. days) and may have one or more specific time of day constraints.

Merchant sets up an on demand spot market marketing campaign: Merchant logs on to registered account on mobile device or merchant web portal. Merchant selects New Offer or chooses to clone or update and existing offer. Merchant enters spot market information on merchant offer screen, which includes selecting category and sub-categories for offered product or services, entering the offer description, entering the offer fine prints and offer details, selecting or uploading logo or image specific to offer, entering number of units being offered (e.g. 10 premium car washes), entering the maximum number of units an individual can claim per offer, and selecting the pricing model and enters required pricing information.

It is noted that, in an embodiment, it may required for the merchant to input a minimum discount percentage which will be automatically calculated and may vary type of business and target market segment (spot market, deal-of-day and national accounts), merchant geographical location, size of subscriber merchant and user base, category or sub-category and number of units being offered.

Fixed price—merchant enters the retail price and the discounted price. Example: merchant enters $30 retail and $15 as the discount price.

Percent off—merchant enters the percentage off amount. Example: merchant enters 20% off.

Dollar amount off—merchant enters the amount of the dollar off amount.

Example: merchant enters $5 off.

Graduated pricing—price scales up in 5 increments. Merchant sets maximum and minimum price. Example: merchant offers 100 units starting at a minimum price of $20 with increments of $1. System automatically calculates tiered pricing. The first 20 voucher are sold for $20, next 20 for $21, next 20 for $22, etc.

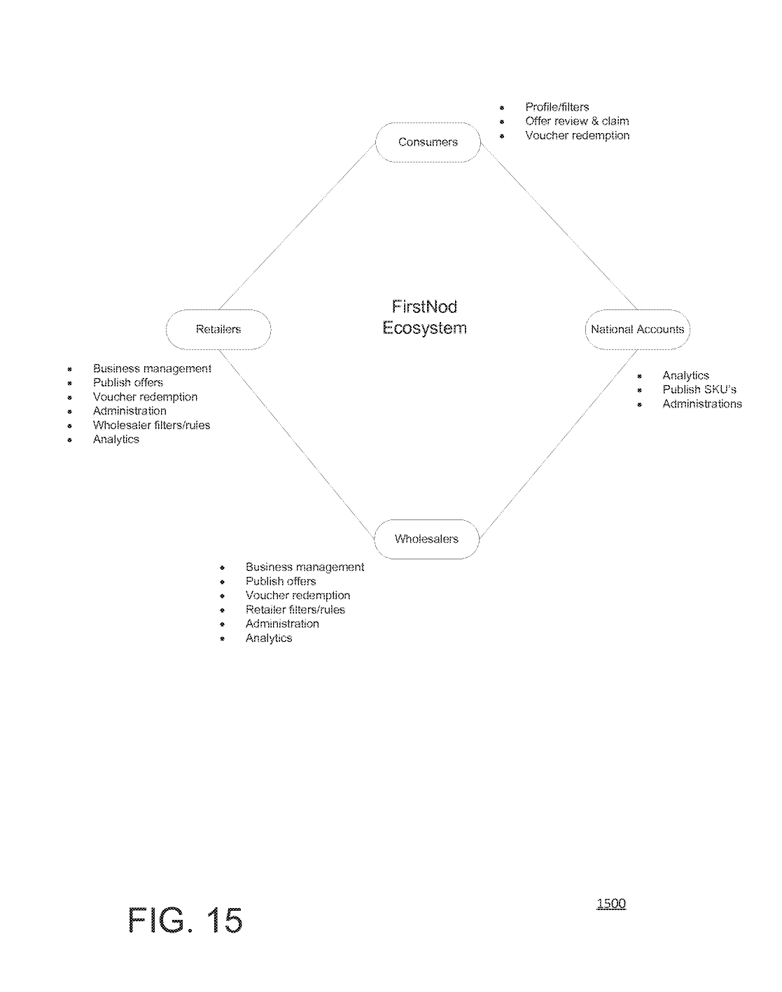

FIG. 15 illustrates an exemplary diagram of an ecosystem for a merchandising platform according to an embodiment.

In an embodiment, FIGS. 1-14 describe the merchandising platform with respect to the consumers and the retails.

In an embodiment, method provides technology and processes for automated business-to-business marketing of goods and services between business entities (e.g., retailers and wholesalers, retailers and national accounts, and wholesalers and national accounts). Method provides a business with a need to acquire, both current and future, products and services to define automated business rules used to define their product and service needs, both individually or concatenated, including category and sub-categories of product or service, size, timing requirements, price, unit quantity, and distance. Method is a key component of Firstnod's business ecosystem.

Business entities may be comprised of wholesalers, merchants, retailers, small business owners, etc. Method provides for the following:

Buyer—businesses with a defined product and service acquisition, barter or trade need

Business can use system to define business rules to filter and pull various marketing offers published by Sellers

Business rules can be comprised of one or more filter criteria such as category and sub-categories of product or service, size, timing requirements, price, unit quantity, delivery restrictions and distance from buyer.

Seller offers matching the buyer's filter criteria are presented to the buyer electronically (email, push notification, wearable device, on the web, social media accounts (Twitter, Facebook, Instagram, etc.)) and other means as they become available.

Buyer can claim the offer presented via the delivery method defined by the Buyer or on the website

Seller—businesses looking to sell, barter or trade products and service to another business

Business will use the methods automated processes to publish offer for product or service they want to sell, trade, barter to another business

Business will define automated business rules relative to the product or service being offered include category and sub-categories of the product or service, unit quantity available, price, available dates, distance restrictions from sellers location.

Alternatively, Seller can send offer directly to Seller's private contact list(s) and flag the offer as “private” (restricting the offer from being published to the general registered user business population (registered users)).

Business will publish the offer and offer will be directed to qualifying registered “Buyer” businesses.

Method will use both the Buyer and Seller's business rules to automatically direct Seller's offer to the correct Buyers vis the communication means defined by the Buyer business.

### Example

### Buyer

A business, the Buyer, uses the method to define business rules related to a specific product or service need. In this case the need for new 16 oz bottles for their brewery.

Buyer selects a category/sub-category for the product. In this case Food services/bottles/beer bottles/16 oz

Buyer defines unit quantity desired (10 cases), size (16 oz), date/time when needed (Oct. 1, 2014), and delivery needs (delivered)

Seller

Seller can query the system's database to see current Buyer analytics to determine if Buyers are in need of Seller's products or services

Seller uses the method to define the offer to be published. In this case they will select the category for the product or category offered (Food services/bottles/beer bottles/16 oz), select unit quantity available (200 cases), enter unit price and delivery information, and availability dates.

Seller decides to publish the offer to all registered business users or to one or more private contact lists. Seller can publish the offer now but not have it actually delivered to the business until a later date.

When seller publishes the offer, only registered users, and/or contact lists, that have defined business rules specifying that they want to receive this type of offer will actually receive an electronic notification that the offer is available.

Example Implementation of a Merchandising Platform According to an Embodiment:

I. Consumer Mobile and Web Experience

Processes and functionality described below are supported using mobile devices and on the web via traditional data entry, voice command or motion.

A. Consumer Registration and Sign In

1. New User Registration

In one embodiment, a user registers for services by selecting Sign Up from their mobile device or from consumer website. User enters data in required fields via voice command or data entry. Once all required fields are entered and saved user is taken to user's profile page on the mobile device or website. User enters additional data on the profile page to provide further information about the user such as their address, Facebook, Twitter and SMS account information.

User is sent a confirmation email to the entered email address. User registration is completed upon successfully responding to the email via the received link.

2. Existing User Sign In

Registered users can sign in by entering a valid user id and password or by selecting Sign In using one of their social media accounts.

3. Forgot Password

If user forgets their password they can select Forgot Password from the Sign In screen. User is required to enter their email address and select Reset Password. An email is sent to the user providing information on how to reset their password.

B. Consumer Configurable Shopping Experience

1. Marketing Filters

Techniques are described for automatically filtering which business products and services are presented to user based on filters defined by the user using data entry techniques or voice commands on mobile devices or on the web. Filters encompass category and subcategory of products and services offered by a business, relative location of the business to user's address and mobile device, weather conditions, time of day and the location of a business in relationship to other businesses. Technique also includes the automatic delivery and response of business messaging to user via various delivery messages such as email, notifications, SMS messaging, Twitter, Instagram and Facebook. Current filters incorporate Categories, Communication and Location Services techniques.

2. Marketing Categories

Techniques are described for user to define product and service category and sub-category filter criteria. Product and service categories and sub-categories are automatically filtered by the invention when merchant publishes new marketing campaigns. Merchant products and services passing user defined category and sub-category filter criteria are automatically pulled and delivered to consumers web and mobile device for further review. Technique embodies the display or verbalization of a list of business product and service categories and sub-categories, providing a count of previously selected subcategories, and providing means for user to select specific subcategories of business products and services, which are automatically incorporated into users filter criteria.

3. Marketing Communication

Techniques are described for automatically delivering filtered business product and service messaging directly to user via email, SMS, Twitter, Facebook, Instagram and push notification messaging at user designated times of day. User defines their preferred method(s) of messaging. Frequency of user messaging is configured by user and incorporates messaging at designated times during the day and as messaging is available.

4. Marketing Location Services

Techniques are described for determining the geographic location of user in relationship to one or more merchants whose location is represented within a user defined geographic location. Techniques include obtaining information about the actual location of user's home address and mobile devices, automatically establishing a radius around said locations based on user defined location parameters and automatically analyzing the information to identify merchant product and services of interest to user within the geographic area.

In one embodiment, a user enters geographic location parameters via voice command, data entry or the drawing of a circle in relationship to user defined street address or portion thereof and/or location of user mobile device(s). Geographic location is used to automatically establish a radius encompassing an area or subarea around user's address or mobile device to automatically identify merchants located within the area or subarea. After automatically identifying the merchant, automatically comparing category and sub-category of services and products offered by merchant within the area or subarea against user defined filter criteria to determine if merchant has products and services of interest to user within the user defined area or subarea.

In one embodiment a user can configure devices to include merchant offers that are relative to one another or are cross marketing opportunities. An example: consumer is at merchant #1's location and redeems a voucher. Merchant #2 can pre-publish an offer that is automatically pulled and delivered to the consumer if consumer redeems another merchant's voucher within a defined distance from another merchant. In this case when consumer redeems offer from merchant #1 the offer from merchant #2 is automatically pulled and delivered in real-time to consumers web or mobile device.

5. Offer Management and Processing

In one embodiment, offers are products and services published by a merchant and offered to consumers. Offers are pulled by the web or mobile device and delivered to the consumer based on consumer defined filter criteria.

Businesses use the merchant portal to create marketing campaigns and identify the target market for individual campaigns. Using the Merchant portal the business will publish offers making it available for users to automatically pull the marking information based on user defined filter criteria. Offers meeting filter criteria defined by the user are delivered to the user using communication preferences defined by the user and are also presented to the user on the offers tab on both the consumer web portal and mobile app. User can search for, monitor and view merchant offers falling outside of user-defined filters using both the consumer web portal and mobile app.

6. Offer Claim Process

In embodiments, offers can be viewed and claimed by user using the consumer web portal, mobile device or the communication delivery methods defined by user. Offers claimed by user are maintained within the system as vouchers and are viewable by user on the voucher screen on the consumer web portal and mobile app.

7. Voucher Management and Processing

Offers claimed by user are maintained in a database as Vouchers. Vouchers comprise 3 statuses: Active Vouchers—vouchers claimed by user and are still available to be redeemed by the merchant; Used Vouchers—vouchers claimed by user and have been marked by the user, merchant or both as redeemed; Expired Vouchers—vouchers claimed by user, were never redeemed and have subsequently expired.

II. Merchant Configurable Marketing Experience

The invention provides merchants with the utmost in flexibility to self define marketing campaigns, target specific markets, set pricing and available unit quantities, establish availability dates spanning one or multiple dates, available time of day in 15 minute increments and availability based on local weather conditions.

B. Merchant Registration and Sign In

1. New Merchant Registration

In one embodiment, merchant registration is self-service and requires little interaction between merchant and FirstNod's team. In one embodiment, merchant registers for service by selecting Sign Up from their mobile device or merchant website. Merchant enters data in required fields via voice command or data entry. Once all required fields are entered and saved merchant is taken to merchants profile page where merchant enters additional data. Information is then stored in the database.

A confirmation email is sent to the entered email address. After successful response to delivered email, solution automatically reviews and verifies business authenticity. Once verified, business may commence using FirstNod for marketing.

2. Existing Merchant Sign In

Registered merchants may sign in by entering a valid merchant id and password or by selecting Sign In using one of their social media accounts.

3. Forgot Password

If merchant forgets their password they can select Forgot Password from the Sign In screen. Merchant is required to enter their email address and select Rest Password. An email is sent to the merchant providing information on how to reset their password.

4. Merchant Profile

Merchant manages their individual corporate profile. In addition to contact and financial information merchants can setup and manage multiple locations (physical or web) where they conduct business. The support for multiple locations is a powerful tool that helps facilitate merchants marketing efforts across one or more locations and manage and publish individual marketing campaigns by location.

5. Marketing Administration and Publishing Overview

Core functionality and process automation encapsulated in the invention include marketing and voucher management and metrics reporting.

6. Merchant Offer Management

Offer summary list provides a consolidated list of offer for all statuses. Displayed column labels are sortable. The Offer screen is displayed when an offer in the list is selected. Offers have one of 5 statuses: Active—are published offers that can be actively claimed; Expired—are offers where the date and time parameters are in the past. The offer can no longer be claimed; Scheduled—are offers that the merchant scheduled to be automatically published at a future date and time; Saved—are offers that are saved and not yet published; and Terminated—are offers that were previously published but the merchant subsequently decided to terminate the publication. When terminated the offer can no longer be claimed however all issued vouchers remain active and can be redeemed.

7. Creating a New Offer

Selecting the New Offer button from the Offer Summary screen displays the new offer screen. Data fields include category, sub-category, offer description, fine print, units offered, max per person, weather conditions, pricing model and related displayed field(s), and start and end date.

Redemption details provide great flexibility in establishing the timing or the life of an offer. Offers can expand one or many dates. Within the defined date range user can define what times during the day the offer is valid. Time ranges are defined in 15-minute increments with up to 3 time ranges per day per offer. If a time range is not entered the offer is until midnight on the offer end date.

Offers are effective on the start date and the start time (if any) entered. They expire on the end date at the last time entered (if any). If an end time is not entered the offer will expire at midnight on the end date.

8. Optional Scheduled Publishing

Scheduled Publishing provides merchants with ability to develop and test a marketing campaign and have it automatically published at a future date and time. User enters the date and time in the provided fields, tests the offer, then selects Publish. The offer is displayed on the Offer Summary screen with a status of Pending. When the designated date and time occurs the offer is automatically published and the status is change to Active.

Once required data is entered user may take one of the following actions: Save Offer—saves work in progress offer for later publishing; Test Offer—send a test email, notification and text message to merchant designated accounts; Publish Offer—publishes offer; Cancel—cancels new offer setup process.

9. Change an Existing Offer

Only offers with statuses of Scheduled or Saved can be updated. To update a Scheduled or Saved offer, select the offer from the Offer Summary screen and make desired updates.

10. Delete an Offer

Only Scheduled and Saved offers can be deleted. Pressing the Delete button on the displayed screen will delete the offer from the Offer Summary screen.

11. Clone Existing Offer

Offers with a status of Expired, Pending, Saved, Scheduled and Terminated may be cloned. Cloning is a method to create a duplicate copy of an offer that was previously published. To clone an offer select the offer from the Offer Summary list then select the Clone button on the bottom of the screen. The cloned offer is save with a status of Saved. Merchant can then bring up the saved offer, update it as desired and publish the offer.

12. Merchant Metrics and Reporting

Various metrics and reporting options are made available to merchants via the invention. In many cases merchants are not provided access to specific consumer information. Core functionality include ability to view metrics related to sales by campaign, region, category and sub-category and comparative analysis based on other similar merchants within a zip code, city, state or larger geographic area. Merchants can subscribe to premium services that provide information on consumer shopping characteristics, areas of interest, etc.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as a discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this description, with each claim standing on its own as a separate preferred embodiment of the disclosure.

Moreover, though the description has included a description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method of merchandising using a merchandising platform, comprising:
creating or updating a marketing campaign with one or more data fields related to the marketing campaign;
building one or more marketing messages, each of the marketing messages corresponding to a messaging platform, and each of the marketing messages conforming to one or more rules of the corresponding messaging platform; and
publishing the marketing campaign on the merchandising platform and at least one of the marketing messages on the corresponding messaging platform.

2. The method of claim 1, further comprising:
determining one or more target users to receive the marketing campaign; and
transmitting to the target users the at least one of the marketing messages.

3. The method of claim 2, further comprising determining a preference of the target users for receiving the marketing messages with the corresponding messaging platforms, and wherein the at least one of marketing messages corresponds to the preference.

4. The method of claim 1, wherein the one or more data fields includes one or more of descriptive information of a product or service of the marketing campaign, a merchant location information where the product or service is available, a number of units of where the product or service is available for the marketing campaign, and a date or time of availability.

5. The method of claim 1, wherein the marketing message includes a pointer to a third party system managing or related to the marketing campaign.

6. The method of claim 2, wherein the marketing campaign is private and only available to the target users.

7. The method of claim 1, wherein the one or more rules is based on one or more of element restrictions mandated by the corresponding message platform.

8. The method of claim 7, wherein the building the each of the one or more marketing messages comprises:
weighting the data fields according to the element restrictions mandated by the corresponding message platform; and
building the each of the marketing messages according to a priority of the weighted data fields.

9. The method of claim 8, wherein the element restrictions include one or more of a format, length, or image embedding restriction.

10. The method of claim 1, further comprising storing one or more of the marketing campaign and the marketing messages to a database.

11. The method of claim 1, wherein the corresponding messaging platform meets a preference of a merchant of the marketing campaign.

12. A method of merchandising using a merchandising platform, comprising:
receiving a notification of a redemption event of a voucher for a first marketing campaign;
determining a physical location of a user of the voucher in the redemption event;
determining one or more marketing campaigns within a proximity of the physical location, the one or more marketing campaigns meeting one or more preferences of the user and a respective merchant of each of the marketing campaigns; and
presenting the one or more marketing campaigns to the user.

13. The method of claim 12, wherein the determining the physical location is based on one or more of a global positioning, triangulation, trilateration, and multilateration wireless location determining process of a device of the user used in the redemption event.

14. The method of claim 12, wherein the determining the physical location is based on a location of a merchant of the first marketing campaign.

15. The method of claim 15, wherein the location of the merchant is provided by the merchant through the redemption event.

16. The method of claim 12, wherein the physical location is one of a current location, a home location, and a work location of the user.

17. The method of claim 12, wherein the proximity of the physical location is based on one or more of a distance and a time of travel to the physical location.

18. The method of claim 12, further comprising prioritizing the one or more marketing campaigns based on one or more of the proximity and the preferences of the user.

19. The method of claim 18, wherein the prioritizing comprises weighing the proximity and the preferences of the user.

20-43. (canceled)

44. A merchandising platform, comprising one or more of (a)—(e) following:
(a) a marketing message generation module configured to:
create or update a marketing campaign with one or more data fields related to the marketing campaign;
build one or more marketing messages, each of the marketing messages corresponding to a messaging platform, and each of the marketing messages conforming to one or more rules of the corresponding messaging platform; and
publish the marketing campaign on the merchandising platform and at least one of the marketing messages on the corresponding messaging platform;
(b) a cross marketing module configured to:
receive a notification of a redemption event of a voucher for a first marketing campaign;
determine a physical location of a user of the voucher in the redemption event;
determine one or more marketing campaigns within a proximity of the physical location, the one or more marketing campaigns meeting one or more preferences of the user and a respective merchant of each of the marketing campaigns; and
present the one or more marketing campaigns to the user;
(c) a transaction fee processing module configured to:
receive a notification of a redemption event of a voucher for a marketing campaign;
retrieve rules related to transaction fee for the marketing campaign related to the voucher; and
calculate a unit transaction fee for the voucher based on a number of pricing tiers, a number of units for each of the pricing tiers, and a unit pricing percentage for the each of the pricing tiers;
(d) a voucher generation module configured to:
receive, from a user, a selection to claim an offer of a marketing campaign;
generate a voucher for a marketing campaign;
receive, from a merchant, a notification of a redemption of the voucher;
validate restrictions on the redemption of the voucher;
report a result of the validating to the merchant; and
responsive to the result being an invalid voucher, receive, from the merchant, a selection to override the invalid voucher; and
(e) an on-demand spot marketing module configured to:
create or update a marketing campaign with one or more data fields related to the marketing campaign, the data fields include a duration and a start time of the marketing campaign;
store the marketing campaign to a database;
start the marketing campaign at the start time; and
publish the marketing campaign on the merchandising platform.
